(19) United States
(12) Patent Application Publication
(10) Pub. No.: US 2007/0211071 A1
(43) Pub. Date: Sep. 13, 2007

(54) Method and apparatus for interacting with a visually displayed document on a screen reader

(76) Inventors: Benjamin Slotznick, Mt. Gretna, PA (US); Stephen C. Sheetz, Lititz, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 11/642,247

(22) Filed: Dec. 20, 2006

Related U.S. Application Data
(60) Provisional application No. 60/751,855, filed on Dec. 20, 2005.

(51) Int. Cl. G09G 5/02

(52) U.S. Cl. 345/594

(57) ABSTRACT

User interaction of a visually displayed document is provided via a graphical user interface (GUI). The document includes, and is parsed into, a plurality of text-based grammatical units. An input device modality is selected from a plurality of input device modalities which determines the type of input device in which a user interacts with to make a selection. One or more grammatical units of the document are then selected using the selected type of input device. Each grammatical unit that is selected is read aloud to the user by loading the grammatical unit into a text-to-speech engine. The text of the grammatical unit is thereby automatically spoken. Furthermore, a switching modality is selected from a plurality of switching modalities. The switching modality determines the manner in which one or more switches are used to make a selection. Using the selected switching modality, a user steps through at least some of the grammatical units in an ordered manner by physically activating one or more switches associated with the GUI. Each activation steps through one grammatical unit. Each grammatical unit that is stepped through is read aloud by loading the grammatical unit into a text-to-speech engine, thereby causing the text of the grammatical unit to be automatically spoken.

### CROSS-REFERENCE TO RELATED APPLICATIONS

This application claims the benefit of U.S. Provisional Application No. 60/751,855 filed Dec. 20, 2005 entitled “User Interface for Stepping Through Functions of a Screen Reader.”

### COMPACT DISC APPENDIX

This patent application includes an Appendix on one compact disc having a file named appendix.txt, created on Dec. 19, 2006, and having a size of 36,864 bytes. The compact disc is incorporated by reference into the present patent application. This compact disc appendix is identical in content to the compact disc appendix that was incorporated by reference into U.S. Patent Application Publication No. 2002/0178007 (Slotznick et al.).

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND TO THE INVENTION

The present invention discloses novel techniques for adding multiple input device modalities and multiple switching modalities, such as switch-scanning (or step-scanning) capabilities, to screen-reader software, such as the Point-and-Read® screen-reader disclosed in U.S. Patent Application Publication No. 2002/0178007 (Slotznick et al.). Portions of U.S. Patent Application Publication No. 2002/0178007 are repeated below, and portions not repeated below are incorporated by reference herein.

1. Using the Point-and-Read screen-reader: To use the Point-and-Read screen-reader, the user moves the cursor (most frequently controlled by a computer mouse or other pointing device) over the screen. The Point-and-Read software will highlight in a contrasting color an entire sentence when the cursor hovers over any part of it. If the user keeps the cursor over the sentence for about a second, the software will read the sentence aloud. Clicking is not necessary. If the user places the cursor over a link, and keeps it there, the software will first cause the computer to read the link, then if the cursor remains over the link, the software will cause the computer to navigate to the link. Pointing devices coupled with highlighting and clickless activation also operate the control features of the software (i.e. the “buttons” located on toolbars, such as “Back”, “Forward”, “Print”, and “Scroll Down”). Keystroke combinations can also be used for a handful of the most important activities, such as reading text and activating links. These actions can be varied through options and preferences.

Unlike many screen-readers, the Point-and-Read screen-reader is designed for people who may have multiple-disabilities, such as the following types of people:

i. People who cannot read or who have difficulty reading, but who can hear and comprehend conversational speech.

ii. People who may have poor vision, but who can see high contrasts.

iii. People with hand-motor limitations who can move and position a pointing device (such as a mouse) but nonetheless may have a difficulty clicking on mouse buttons.

iv. People who may have learning disabilities, or cognitive disabilities (such as traumatic brain injury, mental retardation, or Alzheimer's disease) which make reading difficult.

However, there are people whose vision or manual dexterity is even more limited than currently required for Point-and-Read. Just as importantly, many disabilities are progressive and increase with age, so that some people who have the ability to use Point-and-Read may lose that ability as they age. The present invention is intended to extend some of the benefits of using a screen-reader like Point-and-Read to such people.

(Most screen-readers, and much of assistive technology, focus on compensating for one physical disability, usually by relying upon other abilities and mental acuity. This approach does not help people who have multiple disabilities, especially if one of their disabilities is cognitive.)

With the present invention, as increasing the functionality of a screen-reader such as Point-and-Read, a user's vision can range from good to blind and a user's motor skills can range from utilizing a mouse to utilizing only one switch. This allows a user to continue employing the same software program user interface as he or she transitions over time or with age from few moderate disabilities to many severe ones.

2. Using switches to control computers: Some people with severe physical disabilities or muscle degenerative diseases such as Lou Gehrig's disease (ALS) may have only one or two specific movements or muscles that they can readily control. Yet ingenious engineers have designed single switches that these people can operate to control everything from a motorized wheelchair to a computer program. For example, besides hand operated switches, there are switches that can be activated by an eyelid blinking, or by puffing on a straw-like object.

Many people who are blind or have low vision cannot see (or have difficulty seeing) the computer cursor on a computer screen. They find it difficult or impossible to use a computer pointing device, such as a mouse, to control software. For these people, software that is controlled by a keyboard or switch(es) is easier to use than software controlled by a pointing device, even if these people do not have hand-motor-control disabilities.

3. Using switches and automated step scanning: Automated step scanning allows a person who can use only one switch to select from a multitude of actions. The computer software automatically steps through the possible choices one at a time, and indicates or identifies the nature of each choice to the user by highlighting it on a computer screen, or by reading it aloud, or by some other indicia appropriate to the user's abilities. The choice is highlighted (read or identified) for a preset time, after which the software automatically moves to the next choice and highlights (reads or identifies) this next choice. The user activates (or triggers) the switch when the option or choice that he or she wishes to choose has been identified (e.g., highlighted or read aloud). In this way, a single switch can be used with on-screen keyboards to type entire sentences or control a variety of computer programs. Different software programs may provide different ways of stepping through choices. This type of a process is referred to as “single-switch scanning”, “automatic scanning”, “automated scanning”, or just “auto scanning”.

4. Using two-switch step scanning: If the person can control two different switches, then one switch can be used to physically (e.g., manually) step through the choices, and the other switch can be used to select the choice the user wants. A single switch is functionally equivalent to two switches if the user has sufficient control over the single switch to use it reliably in two different ways, such as by a repeated activation (e.g., a left-mouse click versus a left-mouse double-click) or by holding the switch consistently for different durations (e.g., a short period versus a long period as in Morse code). However, in either event, this will be referred to as “two-switch step scanning”, or “two-switch scanning”.

Automatic scanning may be physically easier for some people than two-switch step scanning. However, two-switch scanning offers the user a simpler cognitive map, and may also be more appropriate for people who have trouble activating a switch on cue.

For both automatic scanning and physical (e.g., manual) step scanning, there is sometimes an additional switch provided that allows the user to cancel his or her selection.

5. Using directed step scanning: The term “directed scanning” is sometimes used when more that two switches are employed to direct the pattern or path by which a scanning program steps through choices. For example, a joy-stick (or four directional buttons) may be used to direct how the computer steps through an on-screen keyboard.

Some software programs not designed primarily for people with disabilities still have scanning features. For example, when Microsoft's Internet Explorer is displaying a page, hitting the Tab key will advance the focus of the program to the next clickable button or hyper-link. (Hitting the Enter key will then activate the link.) Repeatedly hitting the Tab key will advance through all buttons and links on the page.

6. Additional background information: All of these various automated and physical (e.g., manual) methods will be referred to as “switch-scanning”.

“Scanning” is also the term used for converting a physical image on paper (or other media such as film stock) into a digital image, by using hardware called a scanner. This type of process will be referred to as “image scanning”.

The hardware looks, and in many ways works, like a photocopy machine. A variety of manufacturers including Hewlett-Packard and Xerox make scanners. The scanner works in conjunction with image-scanning software to convert the captured image to the appropriate type of electronic file.

In the assistive technology field, products such as the Kurzweil 3000 combine an image scanner with optical character recognition (OCR) software and text-to-speech software to help people who are blind or have a difficulty reading because of dyslexia. Typically, the user will put a sheet of paper with printed words into the scanner, and press some keys or buttons. The scanner will take an image of the paper, the OCR software will convert the image to a text file, and the text-to-speech software will read the page aloud to the user.

The present invention is primarily concerned with switch-scanning. However, when a computer is controlled by switch-scanning, the switch-scanning may be used to activate an image-scanner that is attached to the computer. Also, when an image-scanner is used to convert a paper document into an electronic one, switch scanning may be used to read the document one sentence at a time.

Assistive technology has made great progress over the years, but each technology tends to assume that the user has only one disability, namely, a complete lack of one key sensory input. For example, technology for the blind generally assumes that the user has no useful vision but that the user can compensate for lack of sight by using touch, hearing and mental acuity. As another example, technology for switch-users, generally assumes that the user can operate only one or two switches, but can compensate for the inability to use a pointing device or keyboard by using sight, hearing and mental acuity. As another example, a one-handed keyboard (such as the BAT Keyboard from Infogrip, Inc., Ventura, Calif.) will have fewer keys, but often rely upon “chording” (hitting more than one key at a time) to achieve all possible letters and control keys, thus substituting mental acuity and single-hand dexterity for two-handed dexterity. (The BAT Keyboard has three keys for the thumb plus four other keys, one for each finger.)

If the user has multiple disabilities, disparate technologies frequently have to be cobbled together in a customized product by a rehabilitation engineer. Just as importantly, a person with multiple disabilities may have only partial losses of several inputs. But because each technology usually assumes a complete loss of one type of input, the cobbled together customized product does not use all the abilities that the user possesses. In addition, the customized product is likely to rely more heavily on mental acuity.

However, this is not helpful for people with cognitive disabilities (such as traumatic brain injury or mental retardation), who frequently have some other partial impairment(s), such as poor hand-motor control, or poor vision.

Just as importantly, most screen-readers also tend to focus on one level of disability, so that they are too intrusive for a person with a less severe disability and don't provide sufficient support for a person with a more severe disability. This approach does not help the many people who acquire various disabilities as they age and whose disabilities increase with aging. Just when an aging person needs to switch technologies to ameliorate various increased physical disabilities, he or she might be cognitively less able to learn a new technology.

### BRIEF SUMMARY OF THE INVENTION

User interaction of a visually displayed document is provided via a graphical user interface (GUI). The document includes, and is parsed into, a plurality of text-based grammatical units. An input device modality is selected from a plurality of input device modalities which determines the type of input device in which a user interacts with to make a selection. One or more grammatical units of the document are then selected using the selected type of input device. Each grammatical unit that is selected is read aloud to the user by loading the grammatical unit into a text-to-speech engine. The text of the grammatical unit is thereby automatically spoken. Furthermore, a switching modality is selected from a plurality of switching modalities. The switching modality determines the manner in which one or more switches are used to make a selection. Using the selected switching modality, a user steps through at least some of the grammatical units in an ordered manner by physically activating one or more switches associated with the GUI. Each activation steps through one grammatical unit. Each grammatical unit that is stepped through is read aloud by loading the grammatical unit into a text-to-speech engine, thereby causing the text of the grammatical unit to be automatically spoken.

### BRIEF DESCRIPTION OF THE DRAWINGS

The above summary, as well as the following detailed description of preferred embodiments of the invention, will be better understood when read in conjunction with the following drawings. For the purpose of illustrating the invention, there is shown in the drawings an embodiment that is presently preferred, and an example of how the invention is used in a real-world project. It should be understood that the invention is not limited to the precise arrangements and instrumentalities shown. In the drawings:

FIG. 1 shows a flow chart of a prior art embodiment that is related to the present invention;

FIG. 2 shows a flow chart of a particular step in FIG. 1, but with greater detail of the sub-steps;

FIG. 3 shows a flow chart of an alternate prior art embodiment that is related to the present invention;

FIG. 4 shows a screen capture associated with FIG. 3;

FIG. 5 shows a screen capture of the prior art embodiment related to the present invention displaying a particular web page with modified formatting, after having navigated to the particular web page from the FIG. 3 screen;

FIG. 6 shows a screen capture of the prior art embodiment related to present invention after the user has placed the cursor over a sentence in the web page shown in FIG. 5; and

FIGS. 7-13 show screen captures of another prior art embodiment related to the present invention.

FIG. 14 shows different ways in which five of the keys on a standard QWERTY keyboard can be used to simulate a BAT keyboard or similar five key keyboards in accordance with one preferred embodiment of the present invention.

FIG. 15 shows a flow chart of what actions are taken in the reading mode when any of the five keys are pressed in accordance with one preferred embodiment of the present invention.

FIG. 16 shows a flow chart of what actions are taken in the hyperlink mode when any of the five keys are pressed in accordance with one preferred embodiment of the present invention.

FIG. 17 shows a flow chart of what actions are taken in the navigation mode when any of the five keys are pressed in accordance with one preferred embodiment of the present invention.

FIG. 18 shows a screen shot of an embodiment of the present invention designed for one or two switch step-scanning.

FIG. 19 shows a screen shot of one preferred embodiment of the present invention which may be operated in several different input device modalities and several different switching modalities. The screen shot shows the option page by which the user chooses among the modalities.

### DETAILED DESCRIPTION OF THE INVENTION

Certain terminology is used herein for convenience only and is not to be taken as a limitation on the present invention. In the drawings, the same reference letters are employed for designating the same elements throughout the several figures.

### 1. Definitions

The following definitions are provided to promote understanding of the present invention.

The term “standard method” is used herein to refer to operation of a screen-reader (like Point-and-Read) which operates as described in U.S. Patent Application Publication No. 2002/0178007. Most personal computer programs expect that a user will be able to operate a computer mouse or other pointing devices such as a track-ball or touch-pad. A screen-reader employing the standard method is operated primarily by a pointing device (such as a mouse) plus clickless activation. The standard method can include some switch-based features, for example, the use of keystrokes like Tab or Shift+Tab as described in that application.

In contrast, the term “switch-based method” is used in this patent application to refer to operation of a screen-reader in which all features of the screen-reader can be operated with a handful of switches. Switch-based methods include directed scanning, physical (e.g., manual) step-scanning and automated step-scanning, as well as other control sequences. A switch-based method includes control via six switches, five switches, two switches, or one switch. Switches include the keys on a computer keyboard, the keys on a separate keypad, or special switches integrated into a computing device or attached thereto.

The term “the input device modality” is used herein to refer to the type of input device by which a user interacts with a computer to make a selection. Exemplary input device modalities include a pointing device modality as described above, and a switch-based modality wherein one or more switches are used for selection.

The term “switching modality” is used herein to refer specifically to the number of switches used in the switch-based method to operate the software.

The term “activating a switch” is used in this patent application to refer to pressing a physical switch or otherwise causing a physical switch to close. Many special switches have designed for people with disabilities, including those activated by blinking an eyelid, sipping or puffing on a straw-like object, touching an object (e.g a touchpad or touch screen), placing a finger or hand over an object (e.g. a proximity detector), breaking a beam of light, moving one's eyes, or moving an object with one's lips. The full panoply of switches is not limited to those described in this paragraph.

The term “document modes” is used herein to refer to the various ways in which a document can be organized or abstracted for display or control. The term includes a reading mode which comprises all objects contained in the document or only selected objects (e.g., only text-based grammatical units), a hyperlink mode which comprises all hyperlinks in an html document (and only the hyperlinks), a cell mode which comprises all cells found in tables in a document (and only the cells), and a frame mode which comprises all frames found in an html document (and only the frames). The hyperlink mode may also include other clickable objects in addition to links. The full delineation of documents modes is not limited to those described in this paragraph. Changing a document mode may change the aspects of a document which are displayed, or it may simply change the aspects of a document which are highlighted or otherwise accessed, activated or controlled.

The term “control mode” is used herein to refer to the organization or abstraction of the set of user commands available from a GUI. Most frequently, the control mode is conceived of as a set of buttons on one or more toolbars, but the control mode can also be (without limitation) a displayed list of commands or an interactive region on a computer screen. The control mode can also be conceived of as an invisible list of commands that is recited by a synthesized voice to a blind (or sighted) user. The term “control mode” includes a navigation mode which comprises a subset of the navigation buttons and tool bars used in most Windows programs. Placing the software in control mode allows the user to access controls and commands for the software—as opposed to directly interacting with any document that the software displays or creates.

The term “activating an object” is used herein to refer to causing an executable program (or program feature) associated with an on-screen object (i.e., an object displayed on a computer screen) to run. On-screen objects include (but are not limited to) grammatical units, hyperlinks, images, text and other objects within span tags, form objects, text boxes, radio buttons, submit buttons, sliders, dials, widgets, and other images of buttons, keys, and controls. Ways of activating on-screen objects include (but are not limited to) click events, mouse events, hover (or dwell) events, code sequences, and switch activations. In any particular software program, some on-screen objects can be activated and others cannot.

### 2. Overview of One Prior Art Preferred Embodiment of Present Invention

A preferred embodiment of the present invention takes one web page which would ordinarily be displayed in a browser window in a certain manner (“WEBPAGE 1”) and displays that page in a new but similar manner (“WEBPAGE 2”). The new format contains additional hidden code which enables the web page to be easily read aloud to the user by text-to-speech software.

The present invention reads the contents of WEBPAGE 1 (or more particularly, parses its HTML code) and then “on-the-fly” in real time creates the code to display WEBPAGE 2, in the following manner:
(1) All standard text (i.e., sentence or phrase) that is not within link tags is placed within link tags to which are added an “on Mouseover” event. The on Mouseover event executes a JavaScript function which causes the text-to-speech reader to read aloud the contents within the link tags, when the user places the pointing device (mouse, wand, etc.) over the link. Font tags are also added to the sentence (if necessary) so that the text is displayed in the same color as it would be in WEBPAGE 1—rather than the hyperlink colors (default, active or visited hyperlink) set for WEBPAGE 1. Consequently, the standard text will appear in the same color and font on WEBPAGE 2 as on WEBPAGE 1, with the exception that in WEBPAGE 2, the text will be underlined.
(2) All hyperlinks and buttons which could support an on Mouseover event, (but do not in WEBPAGE 1 contain an on Mouseover event) are given an on Mouseover event. The on Mouseover event executes a JavaScript function which causes the text-to-speech reader to read aloud the text within the link tags or the value of the button tag, when the user places the pointing device (mouse, wand, etc.) over the link. Consequently, this type of hyperlink appears the same on WEBPAGE 2 as on WEBPAGE 1.
(3) All buttons and hyperlinks that do contain an on Mouseover event are given a substitute onMouseover event. The substitute on Mouseover event executes a JavaScript function which first places text that is within the link (or the value of the button tag) into the queue to be read by the text-to-speech reader, and then automatically executes the original on Mouseover event coded into WEBPAGE 1. Consequently, this type of hyperlink appears the same on WEBPAGE 2 as on WEBPAGE 1.
(4) All hyperlinks and buttons are preceded by an icon placed within link tags. These link tags contain an on Mouseover event. This on Mouseover event will execute a JavaScript function that triggers the following hyperlink or button. In other words, if a user places a pointer (e.g., mouse or wand) over the icon, the browser acts as if the user had clicked the subsequent link or button.
   As is evident to those skilled in the art, WEBPAGE 2 will appear almost identical to WEBPAGE 1 except all standard text will be underlined, and there will be small icons in front of every link and button. The user can have any sentence, link or button read to him by moving the pointing device over it. This allows two classes of disabled users to access the web page, those who have difficulty reading, and those with dexterity impairments that prevent them from “clicking” on objects.

In many implementations of JavaScript, for part (3) above, both the original on Mouseover function call (as in WEBPAGE 1) and the new on Mouseover function call used in part (2) can be placed in the same on Mouseover handler. For example, if a link in WEBPAGE 1 contained the text “Buy before lightning strikes” and a picture of clear skies, along with the code

on MouseOver=“ShowLightning( )”

which makes lightning flash in the sky picture, WEBPAGE 2 would contain the code

on MouseOver=“Cursor Over(‘Buy before lightning strikes.’); ShowLightning( );”

The invention avoids conflicts between function calls to the computer sound card in several ways. No conflict arises if both function calls access Microsoft Agent, because the two texts to be “spoken” will automatically be placed in separate queues. If both functions call the sound card via different software applications and the sound card has multi-channel processing (such as ESS Maestro2E), both software applications will be heard simultaneously. Alternatively, the two applications can be queued (one after another) via the coding that the present invention adds to WEBPAGE 2. Alternatively, a plug-in is created that monitors data streams sent to the sound card. These streams are suppressed at user option. For example, if the sound card is playing streaming audio from an Internet “radio” station, and this streaming conflicts with the text-to-speech synthesis, the streaming audio channel is automatically muted (or softened).

In an alternative embodiment, the href value is omitted from the link tag for text (part 1 above). (The href value is the address or URL of the web page to which the browser navigates when the user clicks on a link.) In browsers, such as Microsoft's Internet Explorer, the text in WEBPAGE 2 retains the original font color of WEBPAGE 1 and is not underlined. Thus, WEBPAGE 2 appears even more like WEBPAGE 1.

In an alternative embodiment, a new HTML tag is created that functions like a link tag, except that the text is not underlined. This new tag is recognized by the new built in routines. WEBPAGE 2 appears very much like WEBPAGE 1.

In an alternate embodiment, when the on Mouseover event is triggered, the text that is being read appears in a different color, or appears as if highlighted with a Magic Marker (i.e., the color of the background behind that text changes) so that the user knows visually which text is being read. When the mouse is moved outside of this text, the text returns to its original color. In an alternate embodiment, the text does not return to its original color but becomes some other color so that the user visually can distinguish which text has been read and which has not. This is similar to the change in color while a hyperlink is being made active, and after it has been activated. In some embodiments these changes in color and appearance are effected by Cascading Style Sheets.

An alternative embodiment eliminates the navigation icon (part 4 above) placed before each link. Instead, the on Mouseover event is written differently, so that after the text-to-speech software is finished reading the link, a timer will start. If the cursor is still on the link after a set amount of time (such as 2 seconds), the browser will navigate to the href URL of the link (i.e., the web page to which the link would navigate when clicked in WEBPAGE 1). If the cursor has been moved, no navigation occurs. WEBPAGE 2 appears identical to WEBPAGE 1.

An alternative embodiment substitutes “onClick” events for on Mouseover events. This embodiment is geared to those whose dexterity is sufficient to click on objects. In this embodiment, the icons described in (4) above are eliminated.

An alternative embodiment that is geared to those whose dexterity is sufficient to click on objects does not place all text within link tags, but keeps the icons described in (4) in front of each sentence, link and button. The icons do not have on Mouseover events, however, but rather onClick events which execute a JavaScript function that causes the text-to-speech reader to read the following sentence, link or button. In this embodiment, clicking on the link or button on WEBPAGE 2 acts the same as clicking on the link or button on WEBPAGE 1.

An alternative embodiment does not have these icons precede each sentence, but only each paragraph. The onClick event associated with the icon executes a JavaScript function which causes the text-to-speech reader to read the whole paragraph. An alternate formulation allows the user to pause the speech after each sentence or to repeat sentences.

An alternative embodiment has the on Mouseover event, which is associated with each hyperlink from WEBPAGE 1, read the URL where the link would navigate. A different alternative embodiment reads a phrase such as “When you click on this link it will navigate to a web page at” before reading the URL. In some embodiments, this on Mouseover event is replaced by an onClick event.

In an alternative embodiment, the text-to-speech reader speaks nonempty “alt” tags on images. (“Alt” tags provide a text description of the image, but are not necessary code to display the image.) If the image is within a hyperlink on WEBPAGE 1, the on Mouseover event will add additional code that will speak a phrase such as “This link contains an image of a” followed by the contents of the alt tag. Stand-alone images with nonempty alt tags will be given on Mouseover events with JavaScript functions that speak a phrase such as “This is an image of” followed by the contents of the alt tag.

An alternate implementation adds the new events to the arrays of objects in each document container supported by the browser. Many browsers support an array of images and an array of frames found in any particular document or web page. These are easily accessed by JavaScript (e.g., document.frames[ ] or document.images[ ]). In addition, Netscape 4.0+, supports tag arrays (but Microsoft Internet Explorer does not). In this implementation, JavaScript code then makes the changes to properties of individual elements of the array or all elements of a given class (P, H1, etc.). For example, by writing

document.tags.H1.color=“blue”;

all text contained in <H1> tags turns blue. In this implementation (which requires that the tag array allow access to the hyperlink text as well as the on Mouseover event), rather than parsing each document completely and adding HTML text to the document, all changes are made using JavaScript. The internal text in each <A> tag is read, and then placed in new on Mouseover handlers. This implementation requires less parsing, so is less vulnerable to error, and reduces the document size of WEBPAGE 2.

In a preferred embodiment of the present invention, the parsing routines are built into a browser, either directly, or as a plug-in, as an applet, as an object, as an add-in, etc. Only WEBPAGE 1 is transmitted over the Internet. In this embodiment, the parsing occurs at the user's client computer or Internet appliance—that is, the browser/plug-in combination gets WEBPAGE 1 from the Internet, parses it, turns it into WEBPAGE 2 and then displays WEBPAGE 2. If the user has dexterity problems, the control objects for the browser (buttons, icons, etc.) are triggered by on Mouseover events rather than the onClick or on DoubleClick events usually associated with computer applications that use a graphical interface.

In an alternative embodiment, the user accesses the present invention from a web page with framesets that make the web page look like a browser (“WEBPAGE BROWSER”). One of the frames contains buttons or images that look like the control objects usually found on browsers, and these control objects have the same functions usually found on browsers (e.g., navigation, search, history, print, home, etc.). These functions are triggered by on Mouseover events associated with each image or button. The second frame will display web pages in the form of WEBPAGE 2. When a user submits a URL (web page address) to the WEBPAGE BROWSER, the user is actually submitting the URL to a CGI script at a server. The CGI script navigates to the URL, downloads a page such as WEBPAGE 1, parses it on-the-fly, converts it to WEBPAGE 2, and transmits WEBPAGE 2 to the user's computer over the Internet. The CGI script also changes the URLs of links that it parses in WEBPAGE 1. The links call the CGI script with a variable consisting of the originally hyperlink URL. For example, in one embodiment, if the hyperlink in WEBPAGE 1 had an href-http://www.nytimes.com and the CGI script was at http://www.simtalk.com/cgi-bin/webreader.pl, then the href of the hyperlink in WEBPAGE 2 reads href-http//www.simtalk.com/cgi-bin/webreader.pl?originalUrl=www.nytimes.com. When the user activates this link, it invokes the CGI script and directs the CGI script to navigate to the hyperlink URL for parsing and modifying. This embodiment uses more Internet bandwidth than when the present invention is integrated into the browser, and greater server resources. However, this embodiment can be accessed from any computer hooked to the Internet. In this manner, people with disabilities do not have to bring their own computers and software with them, but can use the computers at any facility. This is particularly important for less affluent individuals who do not have their own computers, and who access the Internet using public facilities such as libraries.

An alternative embodiment takes the code from the CGI script and places it in a file on the user's computer (perhaps in a different computer programming language). This embodiment then sets the home page of the browser to be that file. The modified code for links then calls that file on the user's own computer rather than a CGI server.

Alternative embodiments do not require the user to place a cursor or pointer on an icon or text, but “tab” through the document from sentence to sentence. Then, a keyboard command will activate the text-to-speech engine to read the text where the cursor is placed. Alternatively, at the user's option, the present invention automatically tabs to the next sentence and reads it. In this embodiment, the present invention reads aloud the document until a pause or stop command is initiated. Again at the user's option, the present invention begins reading the document (WEBPAGE 2) once it has been displayed on the screen, and continues reading the document until stopped or until the document has been completely read.

Alternative embodiments add speech recognition software, so that users with severe dexterity limitations can navigate within a web page and between web pages. In this embodiment, voice commands (such as “TAB RIGHT”) are used to tab or otherwise navigate to the appropriate text or link, other voice commands (such as “CLICK” or “SPEAK”) are used to trigger the text-to-speech software, and other voice commands activate a link for purposes of navigating to a new web page. When the user has set the present invention to automatically advance to the next text, voice commands (such as “STOP”, “PAUSE”, “REPEAT”, or “RESUME”) control the reader.

The difficulty of establishing economically viable Internet-based media services is compounded in the case of services for the disabled or illiterate. Many of the potential users are in lower socio-economic brackets and cannot afford to pay for software or subscription services. Many Internet services are offered free of charge, but seek advertising or sponsorships. For websites, advertising or sponsorships are usually seen as visuals (such as banner ads) on the websites' pages. This invention offers additional advertising opportunities.

In one embodiment, the present invention inserts multi-media advertisements as interstitials that are seen as the user navigates between web pages and websites. In another embodiment, the present invention “speaks” advertising. For example, when the user navigates to a new web page, the present invention inserts an audio clip, or uses the text-to-speech software to say something like “This reading service is sponsored by Intel.” In an alternative embodiment, the present invention recognizes a specific meta tag (or meta tags, or other special tags) in the header of WEBPAGE 1 (or elsewhere). This meta tag contains a commercial message or sponsorship of the reading services for the web page. The message may be text or the URL of an audio message. The present invention reads or plays this message when it first encounters the web page. The web page author can charge sponsors a fee for the message, and the reading service can charge the web page for reading its message. This advertising model is similar to the sponsorship of closed captioning on TV.

Several products, including HELPRead, Browser Buddy, and the U.S. Pat. No. 7,137,127 (Slotznick), use and teach methods by which a link can be embedded in a web page, and the text-to-speech software can be launched by clicking on that link. In a similar manner, a link can be embedded in a web page which will launch the present invention in its various embodiments. Such a link can distinguish which embodiment the user has installed, and launch the appropriate one.

Text-to-speech software frequently has difficulty distinguishing heterophonic homographs (or isonyms): words that are spelled the same, but sound different. An example is the word “bow” as in “After the archer shoots his bow, he will bow before the king.” A text-to-speech engine will usually choose one pronunciation for all instances of the word. A text-to-speech engine will also have difficulty speaking uncommon names or terms that do not obey the usual pronunciation rules. While this is not practical in the text of a document meant to be read, a “dictionary” can be associated with a document which sets forth the phonemes (phonetic spelling) for particular words in the document. In one embodiment of the present invention, a web page creates such a dictionary and signals the dictionary's existence and location via a pre-specified tag, object, function, etc. Then, the present invention will get that dictionary, and when parsing the web page, will substitute the phonetic spellings within the on Mouseover events.

The above-identified U.S. Pat. No. 7,137,127 (Slotznick) discloses a method of embedding hidden text captions or commentary on a web page, whereby clicking on an icon or dragging that icon to another window would enable the captions to be read (referred to herein as “spoken captions”). The hidden text could also include other information such as the language in which the caption or web page was written. An alternative embodiment of the present invention uses this information to facilitate real-time on-the-fly translation of the caption or the web page, using the methods taught in the above-identified U.S. Pat. No. 7,137,127 (Slotznick). The text is translated to the language used by the text-to-speech engine.

In an alternative embodiment, the present invention alters the code in the spoken captions as displayed in WEBPAGE 2, so that the commentary is “spoken” by the text-to-speech software when the user places a cursor or pointer over the icon.

In an alternative embodiment of the present invention, a code placed on a web page, such as in a meta tag in the heading of the page, or in the spoken caption icons, identifies the language in which the web page is written (e.g., English, Spanish). The present invention then translates the text of the web page, sentence by sentence, and displays a new web page (WEBPAGE 2) in the language used by the text-to-speech engine of the present invention, after inserting the code that allows the text-to-speech engine to “speak” the text. (This includes the various on Mouseover commands, etc.) In an alternate embodiment, the new web page (WEBPAGE 2) is shown in the original language, but the on Mouseover commands have the text-to-speech engine read the translated version.

In an alternative embodiment, the translation does not occur until the user places a pointer or cursor over a text passage. Then, the present invention uses the information about what language WEBPAGE 1 is written in to translate that particular text passage on-the-fly into the language of the text-to-speech engine, and causes the engine to speak the translated words.

While the above embodiments have been described as if WEBPAGE 1 were an HTML document, primarily designed for display on the Internet, no such limitation is intended. WEBPAGE 1 also refers to documents produced in other formats that are stored or transmitted via the Internet: including ASCII documents, e-mail in its various protocols, and FTP-accessed documents, in a variety of electronic formats. As an example, the Gutenberg Project contains thousands of books in electronic format, but not HTML. As another example, many web-based e-mail (particularly “free” services such as Hotmail) deliver e-mail as HTML documents, whereas other e-mail programs such as Microsoft Outlook and Eudora, use a POP protocol to store and deliver content. WEBPAGE 1 also refers to formatted text files produced by word processing software such as Microsoft Word, and files that contain text whether produced by spreadsheet software such as Microsoft Excel, by database software such as Microsoft Access, or any of a variety of e-mail and document production software. Alternate embodiments of the present invention “speak” and “read” these several types of documents.

WEBPAGE 1 also refers to documents stored or transmitted over intranets, local area networks (LANs), wide area networks (WANs), and other networks, even if not stored or transmitted over the Internet. WEBPAGE 1 also refers to documents created, stored, accessed, processed or displayed on a single computer and never transmitted to that computer over any network, including documents read from removable discs regardless of where created.

While these embodiments have been described as if WEBPAGE 1 was a single HTML document, no such limitation is intended. WEBPAGE 1 may include tables, framesets, referenced code or files, or other objects. WEBPAGE 1 is intended to refer to the collection of files, code, applets, scripts, objects and documents, wherever stored, that is displayed by the user's browser as a web page. The present invention parses each of these and replaces appropriate symbols and code, so that WEBPAGE 2 appears similar to WEBPAGE 1 but has the requisite text-to-speech functionality of the present invention.

While these embodiments have been described as if alt values occurred only in conjunction with images, no such limitation is intended. Similar alternative descriptions accompany other objects, and are intended to be “spoken” by the present invention at the option of the user. For example, closed captioning has been a television broadcast technology for showing subtitles of spoken words, but similar approaches to providing access for the disabled have been and are being extended to streaming media and other Internet multi-media technologies. As another example, accessibility advocates desire that all visual media include an audio description and that all audio media include a text captioning system. Audio descriptions, however, take up considerable bandwidth. The present invention takes a text captioning system and with text-to-speech software, creates an audio description on-the-fly.

While these embodiments have been described in terms of using “JavaScript functions” and function calls, no such limitation is intended. The “functions” include not only true function calls but also method calls, applet calls and other programming commands in any programming languages including but not limited to Java, JavaScript, VBscript, etc. The term “JavaScript functions” also includes, but is not limited to, ActiveX controls, other control objects and versions of XML and dynamic HTML.

While these embodiments have been described in terms of reading sentences, no such limitation is intended. At the user's option, the present invention reads paragraphs, or groups of sentences, or even single words that the user points to.

### 3. Detailed Description of Prior Art Embodiment (Part One)

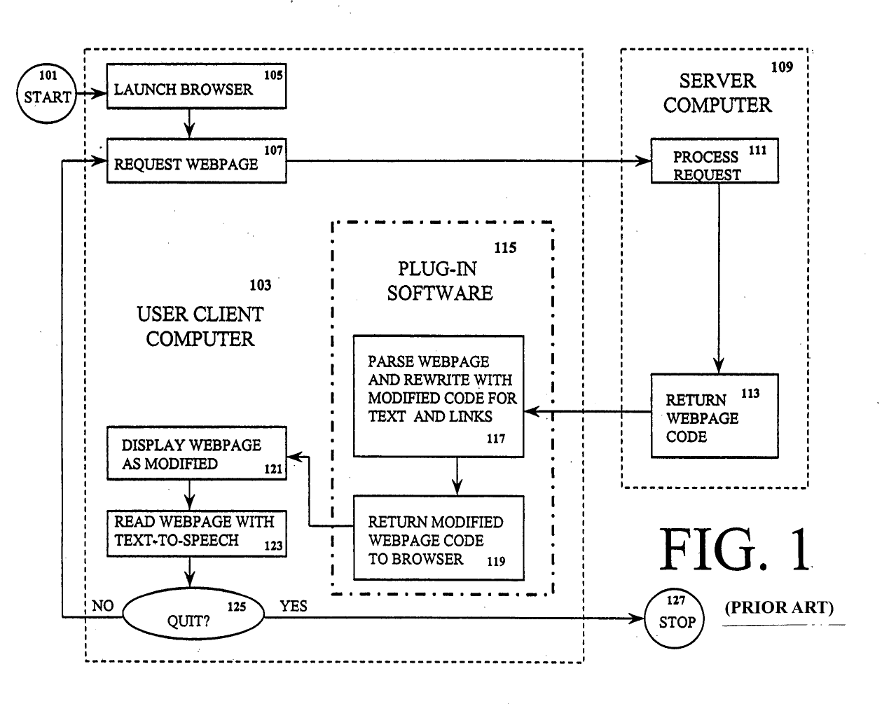

FIG. 1 shows a flow chart of a preferred embodiment of the present invention. At the start 101 of this process, the user launches an Internet browser 105, such as Netscape Navigator, or Microsoft Internet Explorer, from his or her personal computer 103 (Internet appliance or interactive TV, etc.). The browser sends a request over the Internet for a particular web page 107. The computer server 109 that hosts the web page will process the request 111. If the web page is a simple HTML document, the processing will consist of retrieving a file. In other instances, for example, when the web page invokes a CGI script or requires data from a dynamic database, the computer server will generate the code for the web page on-the-fly in real time. This code for the web page is then sent back 113 over the Internet to the user's computer 103. There, the portion of the present invention in the form of plug-in software 115, will intercept the web page code, before it can be displayed by the browser. The plug-in software will parse the web page and rewrite it with modified code of the text, links, and other objects as appropriate 117.

After the web page code has been modified, it is sent to the browser 119. There, the browser displays the web page as modified by the plug-in 121. The web page will then be read aloud to the user 123 as the user interacts with it.

After listening to the web page, the user may decide to discontinue or quit browsing 125 in which case the process stops 127. On the other hand, the user may decide not to quit 125 and may continue browsing by requesting a new web page 107. The user could request a new web page by typing it into a text field, or by activating a hyperlink. If a new web page is requested, the process will continue as before.

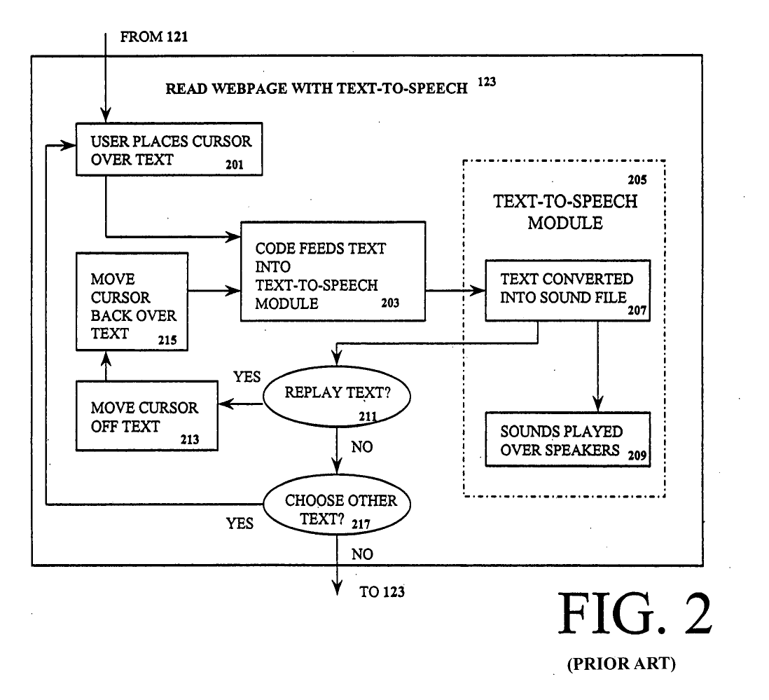

The process of listening to the web page is illustrated in expanded form in FIG. 2. Once the browser displays the web page as modified by the plug-in 121, the user places the cursor of the pointing device over the text which he or she wishes to hear. The code (e.g., JavaScript code placed in the web page by the plug-in software) feeds the text to a text-to-speech module 205 such as DECtalk originally written by Digital Equipment Corporation or TruVoice by Lernout and Hauspie. The text-to-speech module may be a stand-alone piece of software, or may be bundled with other software. For example, the Virtual Friend animation software from Haptek incorporates DECtalk, whereas Microsoft Agent animation software incorporates TruVoice. Both of these software packages have animated “cartoons” which move their lips along with the sounds generated by the text-to-speech software (i.e., the cartoons lip sync the words). Other plug-ins (or similar ActiveX objects) such as Speaks for Itself by DirectXtras, Inc., Menlo Park, Calif., generate synthetic speech from text without animated speakers. In any event, the text-to-speech module 205 converts the text 207 that has been fed to it 203 into a sound file. The sound file is sent to the computers sound card and speakers where it is played aloud 209 and heard by the user.

In an alternative embodiment in which the text-to-speech module is combined or linked to animation software, instructions will also be sent to the animation module, which generate bitmaps of the cartoon lip-syncing the text. The bitmaps are sent to the computer monitor to be displayed in conjunction with the sound of the text being played over the speakers.

In any event, once the text has been “read” aloud, the user must decide if he or she wants to hear it again 211. If so, the user moves the cursor off the text 213 and them moves the cursor back over the text 215. This will again cause the code to feed the text to the text-to-speech module 203, which will “read” it again. (In an alternate embodiment, the user activates a specially designated “replay” button.) If the user does not want to hear the text again, he or she must decide whether to hear other different text on the page 217. If the user wants to hear other text, he or she places the cursor over that text 201 as described above. Otherwise, the user must decide whether to quit browsing 123, as described more fully in FIG. 1 and above.

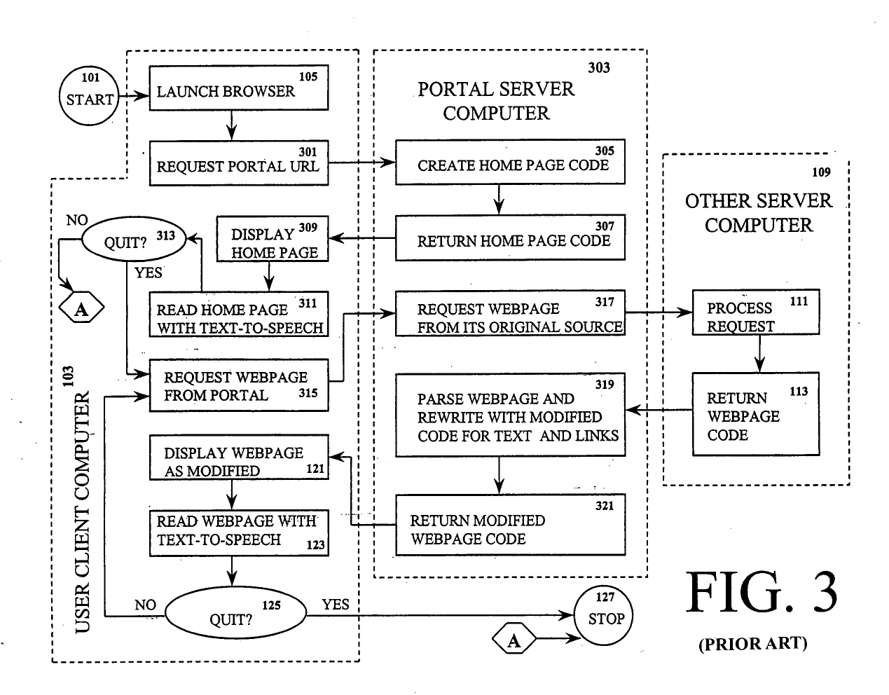

FIG. 3 shows the flow chart for an alternative embodiment of the present invention. In this embodiment, the parsing and modifying of WEBPAGE 1 does not occur in a plug-in (FIG. 1, 115) installed on the user's computer 103, but rather occurs at a website that acts as a portal using software installed in the server computer 303 that hosts the website. In FIG. 3, at the start 101 of this process, the user launches a browser 105 on his or her computer 103. Instead of requesting that the browser navigate to any website, the user then must request the portal website 301. The server computer 303 at the portal website will create the home page 305 that will serve as the WEBBROWSER for the user. This may be simple HTML code, or may require dynamic creation. In any event, the home page code is returned to the user's computer 307, where it is displayed by the browser 309. (In alternate embodiments, the home page may be created in whole or part by modifying the web page from another website as described below with respect to FIG. 3 items 317, 111, 113, 319.)

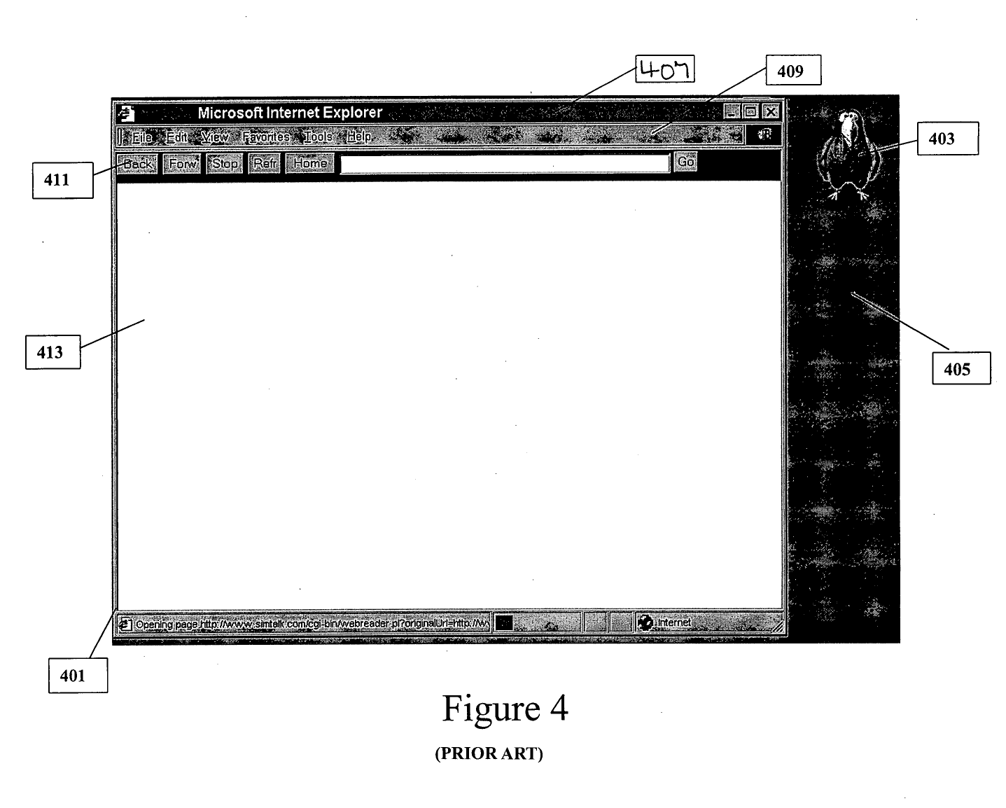

An essential part of the home page is that it acts as a “browser within a browser” as shown in FIG. 4. FIG. 4 shows a Microsoft Internet Explorer window 401 (the browser) filling about ¾ of a computer screen 405. Also shown is “Peedy the Parrot” 403, one of the Microsoft Agent animations. The title line 407 and browser toolbar 409 in the browser window 401 are part of the browser. The CGI script has suppressed other browser toolbars. The area 411 that appears to be a toolbar is actually part of a web page. This web page is a frameset composed of two frames: 411 and 413. The first frame 411 contains buttons constructed out of HTML code.

These are given the same functionality as a browser's buttons, but contain extra code triggered by cursor events, so that the text-to-speech software reads the function of the button aloud. For example, when the cursor is placed on the “Back” button, the text-to-speech software synthesizes speech that says, “Back.” The second frame 413, displays the various web pages to which the user navigates (but after modifying the code).

Returning to frame 411, the header for that frame contains code which allows the browser to access the text-to-speech software. To access Microsoft Agent software, and the Lernout and Hauspie TruVoice text-to-speech software that is bundled with it, “object” tags are placed of the top frame 411.

| <OBJECT | classid=“clsid: .......” |
|---|---|
| | Id =”AgentControl” |
| | CODEBASE=“#VERSION..........” |
| </OBJECT> | |
| <OBJECT | classid=“clsid: .......” |
| | Id =“TruVoice” |
| | CODEBASE=“#VERSION..........” |

</OBJECT>

The redacted code is known to practitioners of the art and is specified by and modified from time to time by Microsoft and Lernout and Hauspie.

The header also contains various JavaScript (or Jscript) code including the following functions “Cursor Over”, “Cursor Out”, and “Speak”:

```
<SCRIPT LANGUAGE=“JavaScript”>
<!-
    ..........
    function CursorOver(theText)
    {
        delayedText = theText;
        clearTimeout(delayedTextTimer);
        delayedTextTimer = setTimeout(“Speak(‘” + theText + “’)”,
        1000);
    }
    function CursorOut( )
    {
        clearTimeout(delayedTextTimer);
        delayedText = “”;
    }
    function Speak(whatToSay)
    {
        speakReq = Peedy.Speak(whatToSay);
    }
    ...........
//- ->
</SCRIPT>
```

The use of these functions written is more fully understood in conjunction with the code for the “Back” button that appears in frame 411. This code references functions known to those skilled in the art, which cause the browser to retrieve the last web page shown in frame 413 and display that page again in frame 413. In this respect the Back” button acts like a typical browser “Back” button. In addition, however, the code for the “Back” button contains the following invocations of the “Cursor Over” and “Cursor Out” functions.

<INPUT TYPE=button NAME=“BackButton” Value=“Back”

. . .

on MouseOver=“Cursor Over(‘Back’)” on MouseOut=“Cursor Out( )”>

When the user moves the cursor over the “Back” button, the on Mouseover event triggers the Cursor Over function. This function places the text “Back” into the “delayedText” variable and starts a timer. After 1 second, the timer will “timeout” and invoke the Speak function. However, if the user moves the cursor off the button before timeout occurs (as with random “doodling” with the cursor), the on Mouseout event triggers the Cursor Out function, which cancels the Speak function before it can occur. When the Speak function occurs, the “delayedText” variable is sent to Microsoft Agent, the “Peedy.Speak( . . . )” command, which causes the text-to-speech engine to read the text.

In this embodiment, the present invention will alter the HTML of WEBPAGE 1 as follows, before displaying it as WEBPAGE 2 in frame 413. Consider a news headline on the home page followed by an underlined link for more news coverage.

EARTHQUAKE SEVERS UNDERSEA CABLES. For more details click here.

The standard HTML for these two sentences as found in WEBPAGE 1 would be:

<P> EARTHQUAKE SEVERS UNDERSEA CABLES.
<A href=“www.nytimes.com/quake54.html”> For more details click here.</A></P>
   The “P” tags indicate the start and end of a paragraph, whereas the “A” tags indicate the start and end of the hyperlink, and tell the browser to underline the hyperlink and display it in a different color font. The “href” value tells the browser to navigate to a specified web page at the New York Times (www.nytimes.com/quake54.html), which contains more details.

The preferred embodiment of the present invention will generate the following code for WEBPAGE 2:
<P><A onMouseOver=“window.top.frame.SimtalkFrame.Cursor Over(‘EARTHQUAKE SEVERS UNDERSEA CABLES.’)”
on MouseOut=“window.top.frames.SimTalkFrame.CursorOut( )”> EARTHQUAKE SEVERS UNDERSEA CABLES.>/A>
<A href=“http://www.simtalk.com/cgi-bin/webreader.pl?originalUrl=www.nytimes.com/quake54.html”
on MouseOver=“window.top.frame.SimtalkFrame.CursorOver(‘For more details click here.’)” on MouseOut=“window.top.frames.SimTalkFrame.CursorOut( )”> For more details click here.</A></P>
   When this HTML code is displayed in either Microsoft's Internet Explorer, or Netscape Navigator, it (i.e., WEBPAGE 2) will appear identical to WEBPAGE 1.

Alternatively, instead of the <A> tag (and its </A> complement), the present invention substitutes a <SPAN> tag (and </SPAN> complement). To make the sentence change color (font or background) while being read aloud, the variable “this” is added to the argument of the function call Cursor Over and Cursor Out. These functions can then access the color and background properties of “this” and change the font style on-the-fly.

As with the “Back” button in frame 411, (and as known to those skilled in the art) when the user places the cursor over either the sentence or the link, and does not move the cursor off that sentence or link, then the MouseOver event will cause the speech synthesis engine to “speak” the text in the Cursor Over function. The “window.top.fram.SimtalkFrame” is the naming convention that tells the browser to look for the Cursor Over or Cursor Out function in the frame 411.

The home page is then read by the text-to-speech software 311. This process is not shown in detail, but is identical to the process detailed in FIG. 2.

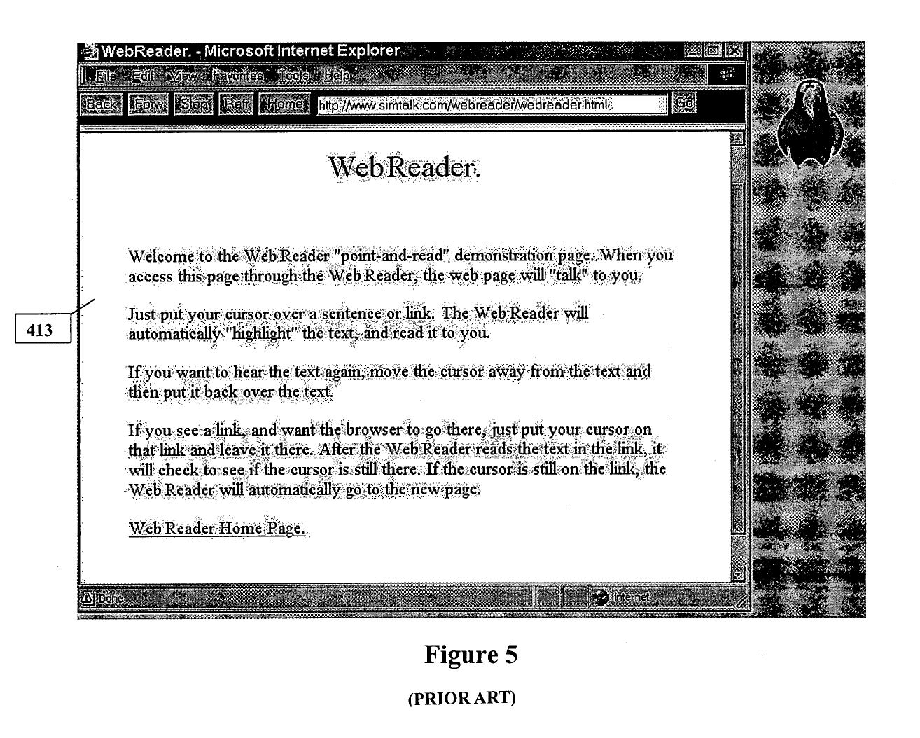

An example of a particular web page (or home page) is shown in FIG. 5. This is the same as FIG. 4, except that a particular web page has been loaded into the bottom frame 413.

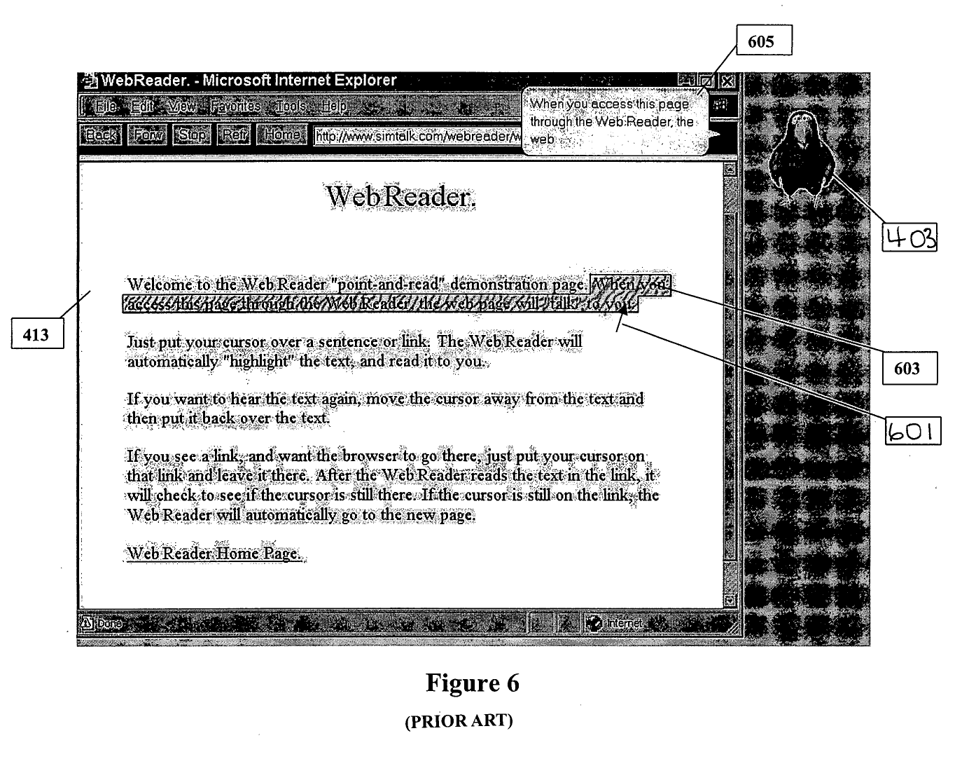

Referring to FIG. 6, when the user places the cursor 601 over a particular sentence 603 (“When you access this page through the web Reader, the web page will “talk” to you.”), the sentence is highlighted. If the user keeps the cursor on the highlighted sentence, the text-to-speech engine “reads” the words in synthesized speech. In this embodiment (which uses Microsoft Agent), the animated character Peedy 403, appears to speak the words. In addition, Microsoft Agent generates a “word balloon” 605 that displays each word as it is spoken. In FIG. 6, the screen capture has occurred while Peedy 403 is halfway through speaking the sentence 603.

The user may then quit 313, in which case the process stops 127, or the user may request a web page 315, e.g., by typing it in, activating a link, etc. However, this web page is not requested directly from the computer server hosting the web page 109. Rather, the request is made of a CGI script at the computer hosting the portal 303. The link in the home page contains the information necessary for the portal server computer to request the web page from its host. As seen in the sample code, the URL for the “For more details click here.” link is not “www.nytimes.com/quake54.html” as in WEBPAGE 1, but rather “http://www.simtalk.com/cgi-bin/webreader.pl?originalUrl=www.nytimes.com/quake54.html”. Clicking on this link will send the browser to the CGI script at simtalk.com, which will obtain and parse the web page at “www.nytimes.com/quake54.html”, add the code to control the text-to-speech engine, and send the modified code back to the browser.

As restated in terms of FIG. 3, when this web page request 315 is received by the portal server computer, the CGI script requests the web page which the user desires 317 from the server hosting that web page 109. That server processes the request 111 and returns the code of the web page 113 to the portal server 303. The portal server parses the web page code and rewrites it with modified code (as described above) for text and links 319.

After the modifications have been made, the modified code for the web page is returned 321 to the user's computer 103 where it is displayed by the browser 121. The web page is then read using the text-to-speech module 123, as more fully illustrated and described in FIG. 2. After the web page has been read, the user may request a new web page from the portal 315 (e.g., by activating a link, typing in a URL, etc.). Otherwise, the user may quit 125 and stop the process 127.

### 4. Detailed Description (Part Two)—Additional Exemplary Prior Art Embodiment

A. Translation to Clickless Point and Read Version

Another example is shown of the process for translating an original document, such as a web page, to a text-to-speech enabled web page. The original document, here a web page, is defined by source code that includes text which is designated for display. Broadly stated, the translation process operates as follows:

1. The text of the source code that is designated for display (as opposed to the text of the source code that defines non-displayable information) is parsed into one or more grammatical units. In one preferred embodiment of the present invention, the grammatical units are sentences. However, other grammatical units may be used, such as words or paragraphs.

2. A tag is associated with each of the grammatical units. In one preferred embodiment of the present invention, the tag is a span tag, and, more specifically, a span ID tag.

3. An event handler is associated with each of the tags. An event handler executes a segment of a code based on certain events occurring within the application, such as on Load or onClick. JavaScript event handers may be interactive or non-interactive. An interactive event handler depends on user interaction with the form or the document. For example, on MouseOver is an interactive event handler because it depends on the user's action with the mouse.

The event handler used in the preferred embodiment of the present invention invokes text-to-speech software code. In the preferred embodiment of the present invention, the event handler is a MouseOver event, and, more specifically, an on MouseOver event. Also, in the preferred embodiment of the present invention, additional code is associated with the grammatical unit defined by the tag so that the MouseOver event causes the grammatical unit to be highlighted or otherwise made visually discernable from the other grammatical units being displayed. The software code associated with the event handler and the highlighting (or equivalent) causes the highlighting to occur before the event handler invokes the text-to-speech software code. The highlighting feature may be implemented using any suitable conventional techniques.

4. The original web page source code is then reassembled with the associated tags and event handlers to form text-to-speech enabled web page source code. Accordingly, when an event associated with an event handler occurs during user interaction with a display of a text-to-speech enabled web page, the text-to-speech software code causes the grammatical unit associated with the tag of the event handler to be automatically spoken.

If the source code includes any images designated for display, and if any of the images include an associated text message (typically defined by an alternate text or “alt” attribute, e.g., alt=“text message”), then in step 3, an event handler that invokes text-to-speech software code is associated with each of the images that have an associated text message. In step 4, the original web page source code is reassembled with the image-related event handlers. Accordingly, when an event associated with an image-related event handler occurs during user interaction with an image in a display of a text-to-speech enabled web page, the text-to-speech software code causes the associated text message of the image to be automatically spoken.

The user may interact with the display using any type of pointing device, such as a mouse, trackball, light pen, joystick, or touchpad (i.e., digitizing tablet). In the process described above, each tag has an active region and the event handler preferably delays invoking the text-to-speech software code until the pointing device persists in the active region of a tag for greater than a human perceivable preset time period, such as about one second. More specifically, in response to a mouseover event, the grammatical unit is first immediately (or almost immediately) highlighted. Then, if the mouseover event persists for greater than a human perceivable preset time period, the text-to-speech software code is invoked. If the user moves the pointing device away from the active region before the preset time period, then the text is not spoken and the highlighting disappears.

In one preferred embodiment of the present invention, the event handler invokes the text-to-speech software code by calling a JavaScript function that executes text-to-speech software code.

If a grammatical unit is a link having an associated address (e.g., a hyperlink), a fifth step is added to the translation process. In the fifth step, the associated address of the link is replaced with a new address that invokes a software program which retrieves the source code at the associated address and then causing steps 1-4, as well as the fifth step, to be repeated for the retrieved source code. Accordingly, the new address becomes part of the text-to-speech enabled web page source code. In this manner, the next web page that is retrieved by selecting on a link becomes automatically translated without requiring any user action. A similar process is performed for any image-related links.

B. Clickless Browser

A conventional browser includes a navigation toolbar having a plurality of button graphics (e.g., back, forward), and a web page region that allows for the display of web pages. Each button graphic includes a predefined active region. Some of the button graphics may also include an associated text message (defined by an “alt” attribute) related to the command function of the button graphic. However, to invoke a command function of the button graphic in a conventional browser, the user must click on its active region.

In one preferred embodiment of the present invention, a special browser is preferably used to view and interact with the translated web page. The special browser has the same elements as the conventional browser, except that additional software code is included to add event handlers that invoke text-to-speech software code for automatically speaking the associated text message and then executing the command function associated with the button graphic. Preferably, the command function is executed only if the event (e.g., mouseover event) persists for greater than a preset time period, in the same manner as described above with respect to the grammatical units. Upon detection of the mouseover event, the special browser immediately (or almost immediately) highlights the button graphic and invokes the text-to-speech software code for automatically speaking the associated text message. Then, if the mouseover event persists for greater than a human perceivable preset time period, the command function associated with the button graphic is executed. If the user moves the pointing device away from the active region of the button graphic before the preset time period, then the command function associated with the button graphic is not executed and the highlighting disappears.

C. Point and Read Process

The point and read process for interacting with translated web pages is preferably implemented in the environment of the special browser so that the entire web page interaction process may be clickless. In the example described herein, the grammatical units are sentences, the pointing device is a mouse, and the human perceivable preset time period is about one second.

A user interacts with a web page displayed on a display device. The web page includes one or more sentences, each being defined by an active region. A mouse is positioned over an active region of a sentence which causes the sentence to be automatically highlighted, and automatically loaded into a text-to-speech engine and thereby automatically spoken. This entire process occurs without requiring any further user manipulation of the pointing device or any other user interfaces associated with display device. Preferably, the automatic loading into the text-to-speech engine occurs only if the pointing device remains in the active region for greater than one second. However, in certain instances and for certain users, the sentence may be spoken without any human perceivable delay.

A similar process occurs with respect to any links on the web page, specifically, links that have an associated text message. If the mouse is positioned over the link, the link is automatically highlighted, the associated text message is automatically loaded into a text-to-speech engine and immediately spoken, and the system automatically navigates to the address of the link. Again, this entire process occurs without requiring any further user manipulation of the mouse or any other user interfaces associated with display device. Preferably, the automatic navigation occurs only if the mouse persists over the link for greater than about one second. However, in certain instances and for certain users, automatic navigation to the linked address may occur without any human perceivable delay. In an alternative embodiment, a human perceivable delay, such as one second, is programmed to occur after the link is highlighted, but before the associated text message is spoken. If the mouse moves out of the active region of the link before the end of the delay period, then the text message is not spoken (and also, no navigation to the address of the link occurs).

A similar process occurs with respect to the navigation toolbar of the browser. If the mouse is positioned over an active region of a button graphic, the button graphic is automatically highlighted, the associated text message is automatically loaded into a text-to-speech engine and immediately spoken, and the command function of the button graphic is automatically initiated. Again, this entire process occurs without requiring any further user manipulation of the mouse or any other user interfaces associated with display device. Preferably, the command function is automatically initiated only if the mouse persists over the active region of the button graphic for greater than about one second. However, in certain instances and for certain users, the command function may be automatically initiated without any human perceivable delay. In an alternative embodiment, a human perceivable delay, such as one second, is programmed to occur after the button graphic is highlighted, but before the associated text message is spoken. If the mouse moves out of the active region of the button graphic before the end of the delay period, then the text message is not spoken (and also, the command function of the button graphic is not initiated). In another alternative embodiment, such as when the button graphic is a universally understood icon designating the function of the button, there is no associated text message. Accordingly, the only actions that occur are highlighting and initiation of the command function.

### D. Illustration of Additional Exemplary Embodiment

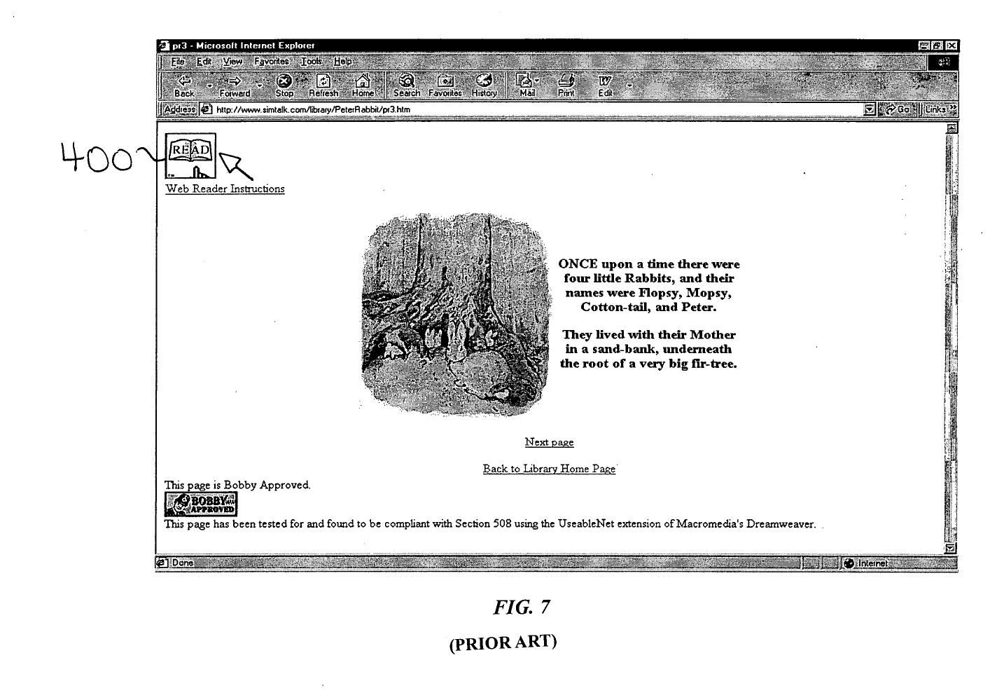

FIG. 7 shows an original web page as it would normally appear using a conventional browser, such as Microsoft Internet Explorer. In this example, the original web page is a page from a storybook entitled “The Tale of Peter Rabbit,” by Beatrix Potter. To initiate the translation process, the user clicks on a Point and Read Logo 400 which has been placed on the web page by the web designer. Alternatively, the Point and Read Logo itself may be a clickless link, as is well-known in the prior art.

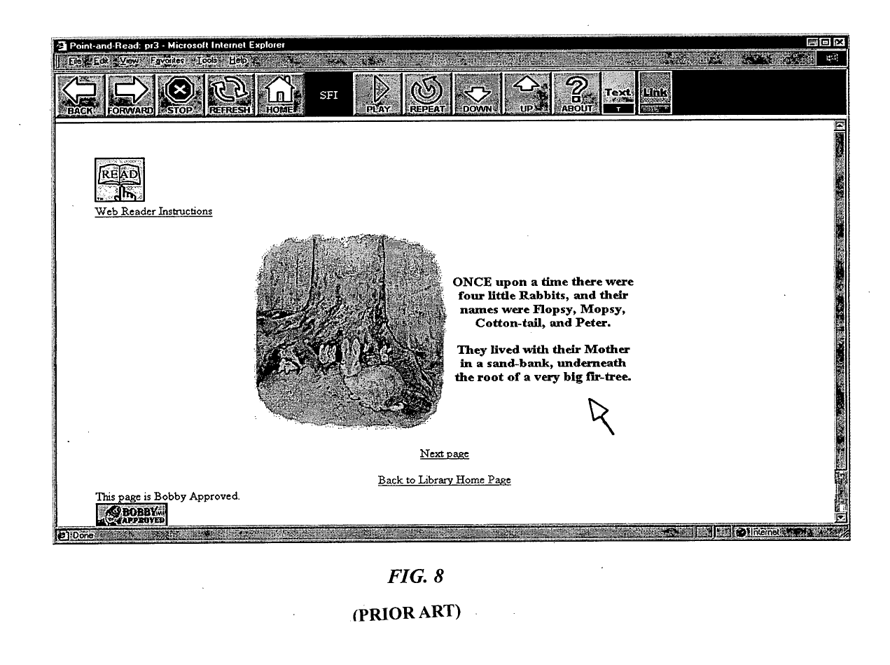

FIG. 8 shows a translated text-to-speech enabled web page. The visual appearance of the of the text-to-speech enabled web page is identical to the visual appearance of the original web page. The conventional navigation toolbar, however, has been replaced by a point and read/navigate toolbar. In this example, the new toolbar allows the user to execute the following commands: back, forward, down, up, stop, refresh, home, play, repeat, about, text (changes highlighting color from yellow to blue at user's discretion if yellow does not contrast with the background page color), and link (changes highlighting color of links from cyan to green at the user's discretion if cyan does not contrast with the background page color). Preferably, the new toolbar also includes a window (not shown) to manually enter a location or address via a keyboard or dropdown menu, as provided in conventional browsers.

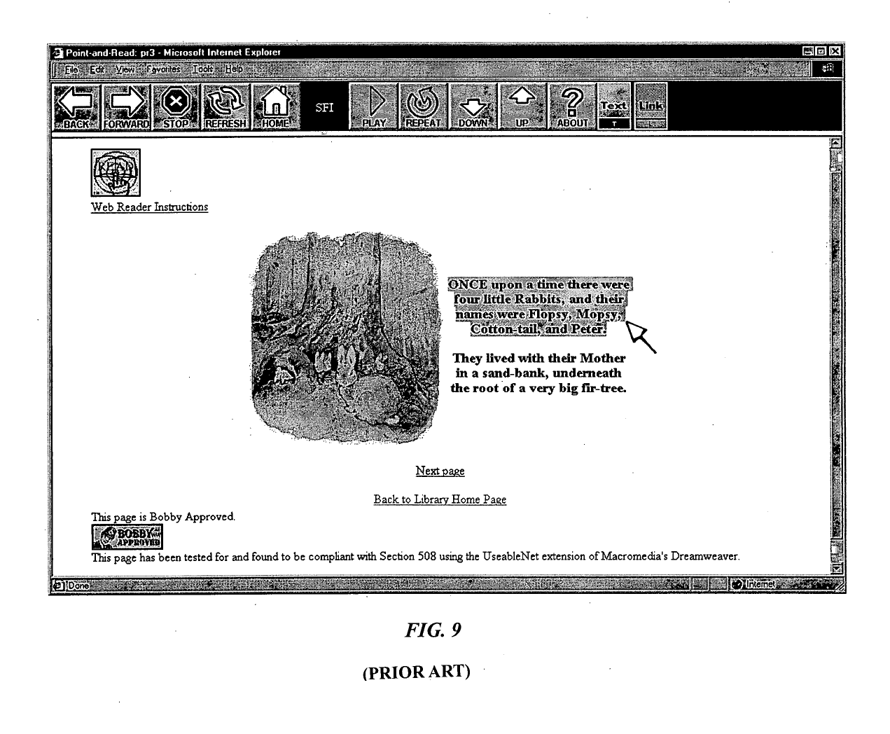

FIG. 9 shows the web page of FIG. 8 wherein the user has moved the mouse to the active region of the first sentence, “ONCE upon a time . . . and Peter.” The entire sentence becomes highlighted. If the mouse persists in the active region for a human perceivable time period, the sentence will be automatically spoken.

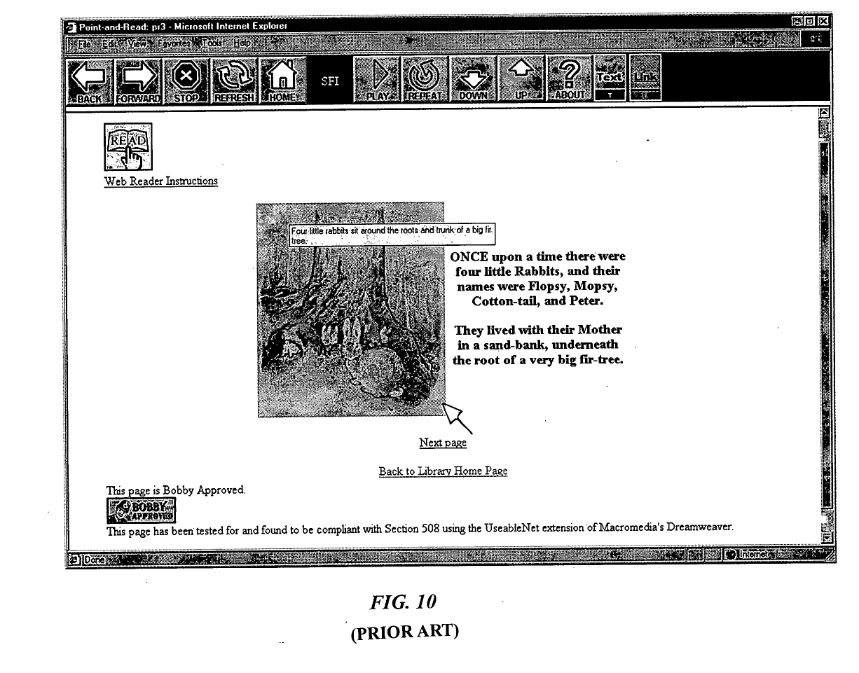

FIG. 10 shows the web page of FIG. 8 wherein the user has moved the mouse to the active region of the story graphics image. The image becomes highlighted and the associated text (i.e., alternate text), “Four little rabbits . . . fir tree,” becomes displayed. If the mouse persists in the active region of the image for a human perceivable time period, the associated text of the image (i.e., the alternate text) is automatically spoken.

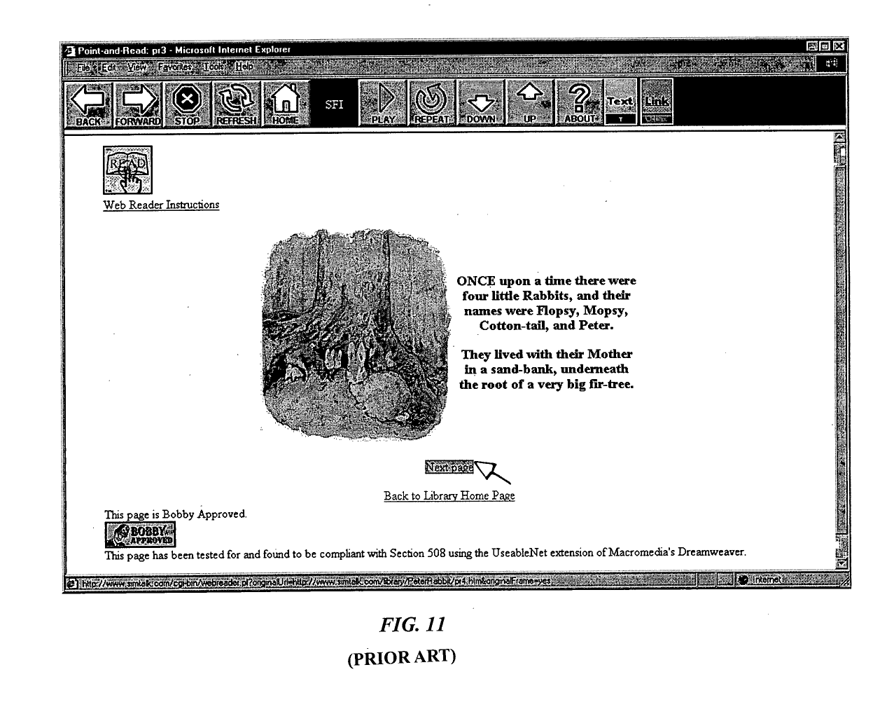

FIG. 11 shows the web page of FIG. 8 wherein the user has moved the mouse to the active region of the “Next Page” link. The link becomes highlighted using any suitable conventional processes. However, in accordance with the present invention, the associated text of the image (i.e., the alternate text) is automatically spoken. If the mouse remains over the link for a human perceivable time period, the browser will navigate to the address associated with the “Next Page” link.

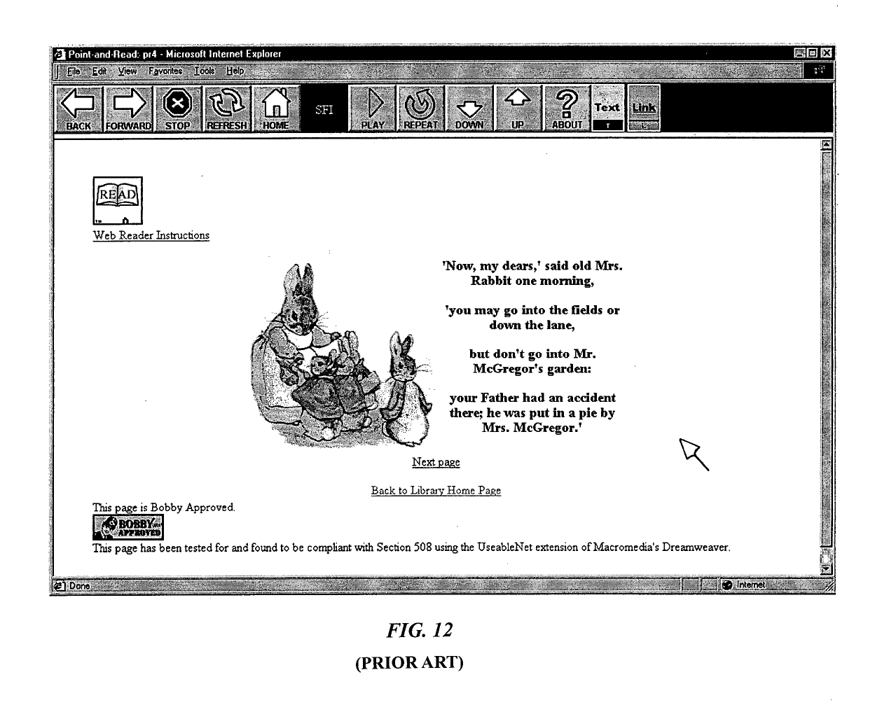

FIG. 12 shows the next web page which is the next page in the story. Again, this web page looks identical to the original web page (not shown), except that it has been modified by the translation process to be text-to-speech enabled. The mouse is not over any active region of the web page and thus nothing is highlighted in FIG. 12.

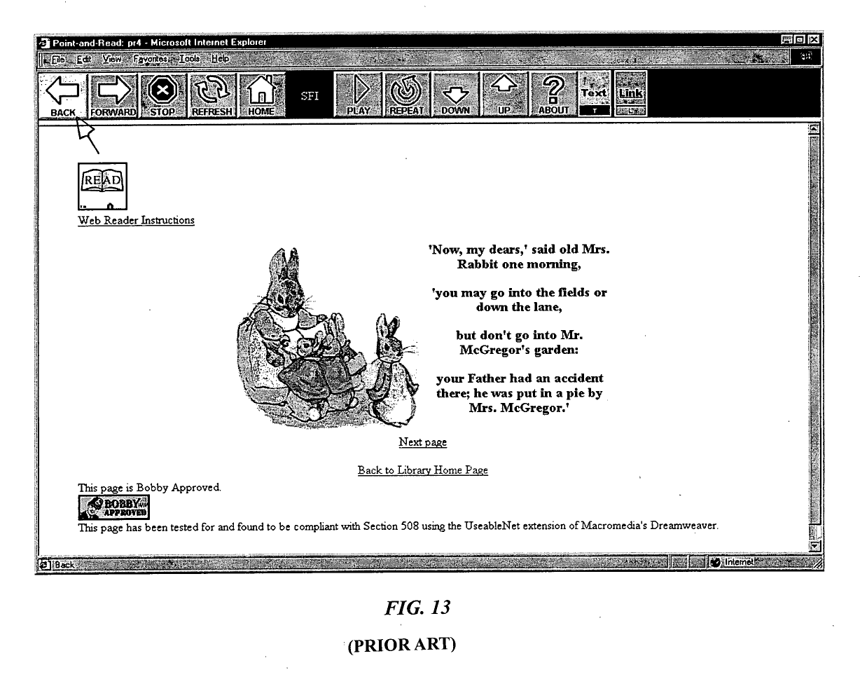

FIG. 13 shows the web page of FIG. 12 wherein the user has moved the mouse to the active region of the BACK button of the navigation toolbar. The BACK button becomes highlighted and the associated text message is automatically spoken. If the mouse remains over the active region of the BACK button for a human perceivable time period, the browser will navigate to the previous address, and thus will redisplay the web page shown in FIG. 8.

With respect to the non-linking text (e.g., sentences), the purpose of the human perceivable delay is to allow the user to visually comprehend the current active region of the document (e.g., web page) before the text is spoken. This avoids unnecessary speaking and any delays that would be associated with it. The delay may be set to be very long (e.g., 3-10 seconds) if the user has significant cognitive impairments. If no delay is set, then the speech should preferably stop upon detection of a mouseOut (onmouseOut) event to avoid unnecessary speaking. With respect to the linking text, the purpose of the human perceivable delay is to inform the user both visually (by highlighting) and aurally (by speaking the associated text) where the link will take the user, thereby giving the user an opportunity to cancel the navigation to the linked address. With respect to the navigation commands, the purpose of the human perceivable delay is to inform the user both visually (by highlighting) and aurally (by speaking the associated text) where the button graphic will take the user, thereby giving the user an opportunity to cancel the navigation associated with the button graphic.

As discussed above, one preferred grammatical unit is a sentence. A sentence defines a sufficiently large target for a user to select. If the grammatical unit is a word, then the target will be relatively smaller and more difficult for the user to select by mouse movements or the like. Furthermore, a sentence is a logical grammatical unit for the text-to-speech function since words are typically comprehended in a sentence format. Also, when a sentence is the target, the entire region that defines the sentence becomes the target, not just the regions of the actual text of the sentence. Thus, the spacing between any lines of a sentence also is part of the active region. This further increases the ease in selecting a target.

The translation process described above is an on-the-fly process. However, the translation process may be built into document page building software wherein the source code is modified automatically during the creation process.

As discussed above, the translated text-to-speech source code retains all of the original functionality as well as appearance so that navigation may be performed in the same manner as in the original web page, such as by using mouse clicks. If the user performs a mouse click and the timer that delays activation of a linking or navigation command has not yet timed out, the mouse click overrides the delay and the linking or navigation command is immediately initiated.

### E. Source Code Associated with Additional Exemplary Embodiment

As discussed above, the original source code is translated into text-to-speech enabled source code. The source code below is a comparison of the original source code of the web page shown in FIG. 7 with the source code of the translated text-to-speech enabled source code, as generated by CompareRite™. Deletions appear as Overstrike text surrounded by { }. Additions appear as Bold text surrounded by [ ].

```
<!DOCTYPE HTML PUBLIC “-//IETF//DTD HTML//EN”>
<html>
<head>
<meta http-equiv=“Content-Type” content=“text/html; charset=iso-8859-1”>
<meta name=“GENERATOR” content=“Microsoft FrontPage 3.0”>
<title>pr3</title>
[<SCRIPT LANGUAGE=‘JavaScript’>
  function TryToSend( )
  {
    try{
      top.frames.SimTalkFrame.SetOriginalUrl(window.location.href);
    }
    catch(e){
      setTimeout(‘TryToSend( );’, 200);
    }
  }
  TryToSend( );
</SCRIPT>
<NOSCRIPT>The Point-and-Read Webreader requires JavaScript to operate.</NOSCRIPT>
<meta http-equiv=“Content-Type” content=“text/html; charset=iso-8859-1”>
<meta name=“GENERATOR” content=“Microsoft FrontPage 3.0”>
<title>pr3</title>
<SCRIPT LANGUAGE=JavaScript>
function AttemptCursorOver(which, theText)
{
        try{ top.frames.SimTalkFrame.CursorOver(which, theText); }
        catch(e){ }
}
function AttemptCursorOut(which)
{
        try{ top.frames.SimTalkFrame.CursorOut(which); }
        catch(e){ }
}
function AttemptCursorOverLink(which, theText, theLink, theTarget)
{
        try{ top.frames.SimTalkFrame.CursorOverLink(which, theText, theLink, theTarget); }
        catch(e){ }
}
function AttemptCursorOutLink(which)
{
        try{ top.frames.SimTalkFrame.CursorOutLink(which); }
        catch(e){ }
}
function AttemptCursorOverFormButton(which)
{
        try{ top.frames.SimTalkFrame.CursorOverFormButton(which); }
        catch(e){ }
}
function AttemptCursorOutFormButton(which)
{
        try{ top.frames.SimTalkFrame.CursorOutFormButton(which); }
        catch(e){ }
}
</SCRIPT>
<NOSCRIPT>The Point-and-Read Webreader requires JavaScript to operate.</NOSCRIPT>]
</head>
<body bgcolor=“#FFFFFF”>
<SCRIPT SRC=“http://www.simtalk.com/webreader/webreader1.js”></SCRIPT>
<NOSCRIPT><P>[<SPAN id=“WebReaderText0” onMouseOver=“AttemptCursorOver(this, ‘
When Java Script is enabled, clicking on the Point-and-Read logo or putting the computers
cursor over the logo (and keeping it there) will launch a new window with the webreeder, a
talking browser that can read this web page aloud.’);”
onMouseOut=“AttemptCursorOut(this);”>]When Java Script is enabled, clicking on the Point-
and-Read&#153; logo or putting the computer's cursor over the logo (and keeping it there) will
launch a new window with the Web Reader, a talking browser that can read this web page
aloud.[</SPAN>]</P></NOSCRIPT>
<p>[
]<

[symbol]

[symbol]

[symbol]

[IMG
SRC=‘http://www.simtalk.com/webreader/webreaderlogo60.gif’ border=2 ALT=‘Point-and-Read
Webreader’ onMouseOver=“AttemptCursorOver(this, ‘Point-and-Read webreeder’);”
onMouseOut=“AttemptCursorOut(this);” >]

[symbol]

[symbol]

[symbol]


[<br><A
HREF=‘http://www.simtalk.com/cgi-
bin/webreader.pl?originalUrl=http://www.simtalk.com/webreader/instructions.html&originalFrame=yes’
onMouseOver=“AttemptCursorOverLink(this, ‘ webreeder Instructions’,
‘http://www.simtalk.com/webreader/instructions.html’, ”);”
onMouseOut=“AttemptCursorOutLink(this);]”
onMouseOver=“WebreaderInstructions_CursorOver( ); return true;”
onMouseOut=“WebreaderInstructions_CursorOut( ); return true;”>
Web Reader Instructions</a></p>
<div align=“center”><center>
<table border=“0” width=“500”>
  <tr>
    <td><h3><IMG SRC= [symbol] [“http://www.simtalk.com/library/PeterRabbit/P3.gif]”
alt=“Four little rabbits sit around the roots and trunk of a big fir tree.”
[onMouseOver=“AttemptCursorOver(this, ‘Four little rabbits sit around the roots and trunk of a
big fir tree.’);” onMouseOut=“AttemptCursorOut(this);”] width=“250”
height=“288”></h3></td>
    <td align=“center”><h3>[<SPAN id=“WebReaderText2”
onMouseOver=“AttemptCursorOver(this, ‘Once upon a time there were four little Rabbits, and
their names were Flopsy, Mopsy, Cotton-tail, and Peter.’);”
onMouseOut=“AttemptCursorOut(this);”>]ONCE upon a time there were four little Rabbits,
      and their names were Flopsy, Mopsy, Cotton-tail, and Peter. [symbol] <[/SPAN></h3>] [symbol]
    [<h3><SPAN id=“WebReaderText3” onMouseOver=“AttemptCursorOver(this, ‘ They
lived with their Mother in a sand-bank, underneath the root of a very big fir-tree.’);”
onMouseOut=“AttemptCursorOut(this);”>]They lived with their Mother in a sand-bank,
underneath the root of a very big
    fir-tree.<[/SPAN><]/h3>
    </td>
  </tr>
</table>
</center></div><div align=“center”><center>
<table border=“0” width=“500”>
    <tr>
      <td><p align=“center”> [symbol] < [A HREF=‘http://www.simtalk.com/cgi-
bin/webreader.pl?originalUrl=http://www.simtalk.com/library/PeterRabbit/pr4.htm&originalFrame=yes’
onMouseOver=“AttemptCursorOverLink(this, ‘Next page’,
‘http://www.simtalk.com/library/PeterRabbit/pr4.htm’, ”);”
onMouseOut=“AttemptCursorOutLink(this);”]>Next page</a></p>
    <p align=“center”>< [symbol]  [A
HREF=‘http://www.simtalk.com/library’ onMouseOver=“AttemptCursorOverLink(this, ‘Back to
Library Home Page’, ‘http://www.simtalk.com/library’, ”);”
onMouseOut=“AttemptCursorOutLink(this);”]>Back to Library
    Home Page</a></td>
  </tr>
</table>
</center></div>
[<SPAN id=“WebReaderText6” onMouseOver=“AttemptCursorOver(this, ‘ This page is Bobby
Approved.’);” onMouseOut=“AttemptCursorOut(this);”>]This page is Bobby Approved. [symbol] [symbol]
<[/SPAN>
<br><A HREF=‘http://www.cast.org/bobby’ ><IMG
onMouseOver=“AttemptCursorOverLink(this, ‘Bobby logo’, ‘http://www.cast.org/bobby’, ”);”
onMouseOut=“AttemptCursorOutLink(this);” SRC]=“http://www.cast.org/images/approved.gif”
alt=“Bobby logo” [symbol]
[onMouseOver=“AttemptCursorOver(this, ‘Bobby logo’);”
onMouseOut=“AttemptCursorOut(this);” ></a><br>
<SPAN id=“WebReaderText7” onMouseOver=“AttemptCursorOver(this, ’] This page has been
tested for and found to be compliant with Section 508 using the UseableNet extension of
[Macromedias Dreamweaver.’);” onMouseOut=“AttemptCursorOut(this);”>This page has been
tested for and found to be compliant with Section 508 using the UseableNet extension of]
Macromedia's Dreamweaver.[</SPAN><SPAN id=“WebReaderText8”
onMouseOver=“AttemptCursorOver(this, ‘ ’);” onMouseOut=“AttemptCursorOut(this);”>
</SPAN>
<SCRIPT LANGUAGE=JavaScript>
      function AttemptStoreSpan(whichItem, theText)
      {
        top.frames.SimTalkFrame.StoreSpan(whichItem, theText);
      }
      function SendSpanInformation( )
      {
        try
        {
          AttemptStoreSpan(document.all.WebReaderText0, “ When Java Script is
enabled, clicking on the Point-and-Read logo or putting the computers cursor over the logo (and
keeping it there) will launch a new window with the webreeder, a talking browser that can read
this web page aloud.”);
          AttemptStoreSpan(document.all.WebReaderText1, “ webreeder
Instructions”);
          AttemptStoreSpan(document.all.WebReaderText2, “Once upon a time
there were four little Rabbits, and their names were Flopsy, Mopsy, Cotton-tail, and Peter.”);
          AttemptStoreSpan(document.all.WebReaderText3, “ They lived with their
Mother in a sand-bank, underneath the root of a very big fir-tree.”);
          AttemptStoreSpan(document.all.WebReaderText4, “ Next page”);
          AttemptStoreSpan(document.all.WebReaderText5, “ Back to Library
Home Page”);
          AttemptStoreSpan(document.all.WebReaderText6, “ This page is Bobby
Approved.”);
          AttemptStoreSpan(document.all.WebReaderText7, “ This page has been
tested for and found to be compliant with Section 508 using the UseableNet extension of
Macromedias Dreamweaver.”);
        }
        catch(e)
        {
            setTimeout(“SendSpanInformation( )”, 1000);
        }
      }
      SendSpanInformation( );
</SCRIPT>
<NOSCRIPT>The Point-and-Read Webreader requires JavaScript to operate.</NOSCRIPT>]
</body>
</html>
```

The text parsing required to identify sentences in the original source code for subsequent tagging by the span tags is preferably performed using Perl. This process is well known and thus is not described in detail herein. The Appendix provides source code associated with the navigation toolbar shown in FIGS. 8-13.

### E. Client-Side Embodiment

An alternative embodiment of the web reader is coded as a stand-alone client-based application, with all program code residing on the user's computer, as opposed to the online server-based embodiment previously described. In this client-based embodiment, the web page parsing, translation and conversion take place on the user's computer, rather than at the server computer.

The client-based embodiment functions in much the same way as the server-based embodiment, but is implemented differently at a different location in the network. This implementation is preferably programmed in C++, using Microsoft Foundation Classes (“MFC”), rather than a CGI-type program. The client-based Windows implementation uses a browser application based on previously installed components of Microsoft Internet Explorer.

Instead of showing standard MFC buttons on the user interface, this implementation uses a custom button class, one which allows each button to be highlighted as the cursor passes over it. Each button is oversized, and allows an icon representing its action to be shown on its face. Some of these buttons are set to automatically stay in an activated state (looking like a depressed button) until another action is taken, so as to lock the button's function to an “on” state. For example, a “Play” button activates a systematic reading of the web page document, and reading continues as long as the button remains activated. A set of such buttons is used to emulate the functionality of scroll bars as well.

The document highlighting, reading and navigation is accomplished in a manner similar to the server-based embodiment following similar steps as the online server-based webreaders described above.

First, for the client-based embodiment, when the user's computer retrieves a document (either locally from the user's computer or from over the Internet or other network), the document is parsed into sentences using the “Markup Services” interface to the document. The application calls functions that step through the document one sentence at a time, and inserts span tags to delimit the beginning and end of each sentence. The document object model is subsequently updated so that each sentence has its own node in the document's hierarchy. This does not change the appearance of the document on the screen, or the code of the original document.

The client-based application provides equivalent functionality to the on MouseOver event used in the previously described server-based embodiment. This client-based embodiment, however, does not use events of a scripting language such as Javascript or VBScript, but rather uses Microsoft Active Accessibility features. Every time the cursor moves, Microsoft Active Accessibility checks which visible accessible item (in this case, the individual sentence) the cursor is placed “over.” If the cursor was not previously over the item, the item is selected and instructed to change its background color. When the cursor leaves the item's area (i.e., when the cursor is no longer “over” the item), the color is changed back, thus producing a highlighting effect similar to that previously described for the server-based embodiment.

When an object such as a sentence or an image is highlighted, a new timer begins counting. If the timer reaches its end before the cursor leaves the object, then the object's visible text (or alternate text for an image) is read aloud by the text-to-speech engine. Otherwise, the timer is cancelled. If the item (or object) has a default action to be performed, when the text-to-speech engine reaches the end of the synthetically spoken text, another timer begins counting. If this timer reaches its end before the cursor leaves the object, then the object's default action is performed. Such default actions include navigating to a link, pushing or activating a button, etc. In this way, clickless point-and-read navigation is achieved and other clickless activation is accomplished.

The present invention is not limited to computers operating a Windows platform or programmed using C++. Alternate embodiments accomplish the same steps using other programming languages (such Visual Basic), other programming tools, other browser components (e.g., Netscape Navigator) and other operating systems (e.g., Apple's MacIntosh OS).

An alternate embodiment does not use Active Accessibility for highlighting objects on the document. Rather, after detecting a mouse movement, a pointer to the document is obtained. A function of the document translates the cursor's location into a pointer to an object within the document (the object that the cursor is over). This object is queried for its original background color, and the background color is changed. Alternately, one of the object's ancestors or children is highlighted.

### 5. Overview of Another Preferred Embodiment of the Present Invention

The present invention discloses improvements to the Point-and-Read screen reader for users who need to use switches to interact with computers. However, novel concepts in the present invention may also be applied to other screen-reader software.

One preferred embodiment of the present invention allows the user to select an input device modality from a plurality of input device modalities. The input device modality determines the type of input device in which a user interacts with to make a selection. Exemplary input device modalities include a pointing device as described above, and one or more switches. In the preferred embodiment described above, only one input device modality is provided, and thus there is no need to select an input device modality.

Another preferred embodiment of the present invention allows the Point-and-Read screen-reader to be controlled by five-switches. The five switch actions are (1) step forward, (2) step backward, (3) repeat current step, (4) activate a button, link, or clickable area at the current step, and (5) change mode or switch to a different set of steps. These five switch actions each work in similar ways within three “modes” or domains: (a) reading mode, (b) hyperlink mode, and (c) navigation mode.

Reading mode is used when the user is reading the contents of a web page or electronic document. This mode will also read any hyperlinks (or clickable areas) embedded within the text. Hyperlink mode is used when the user wants to read just the hyperlinks (or clickable areas) on a page. A user might read the entire page in reading mode, but remember a particular link he or she wants to activate. Instead of reading through the entire page again, the user can just review the links in hyperlink mode. Navigation mode is used when the user wants to use the buttons, menu headings, menus, or other navigation controls that are on the screen-reader's tool bar. Navigation controls frequently include “Back”, “Forward”, “Stop”, “Refresh”, “Home”, “Search”, and “Favorites” that would typically be found on the tool bar of an Internet browser, such as Internet Explorer. Other controls, such as “Font Size” or “Choice of Synthesized Voice” might be standard on screen-reader tool bars.

When a screen-reader such as Point-and-Read is placed in “reading mode”, that is, when the cursor is over the electronic text displayed on the screen, the five switches initiate the following actions. “Step forward” highlights and reads aloud the next sentence or screen element. If a sentence has one or more links within it, the screen-reader first reads the sentence, then the next step forward will read the first link in the sentence (highlighting it in the special hyperlink color). Subsequent step forward actions will read and highlight subsequent links in the sentence. When all links within the sentence have been read, the step forward action reads and highlights the next sentence. “Step backward” highlights and reads aloud the previous sentence or screen element. “Repeat current” reads aloud the currently highlighted sentence (i.e., the last spoken sentence or screen element) one more time. “Activate an action” triggers a hyperlink that is highlighted. (A link is read aloud using one of the first three actions). “Change mode” switches to “hyperlink mode”.

For a comparison between the “reading mode” in the switch-based method of operation and the standard method (pointing device-based) operation of Point-and-Read: “step forward” in the “reading mode” works similarly to pressing the Tab button in the standard method of Point-and-Read, “step backward” works similarly to pressing the Shift and Tab buttons together in the standard method of Point-and-Read, and “activate” works similarly to pressing the Space bar in the standard method of Point-and-Read. The standard method of Point-and-Read currently allows the “repeat current” function to be assigned to the spacebar (or “any key”). However, the standard method of Point-and-Read has no button, switch or keystroke that functions to “change mode”.

“Hyperlink mode” does not change the display on the computer screen, but it can be visualized as a virtual list of the hyperlinks and clickable buttons or areas embedded in the text. “Step forward” highlights and reads aloud the next clickable hyperlink, button or area. Though the entire text remains displayed on the screen, “step forward” causes the cursor (and/or highlighting) to jump to the next hyperlink or clickable area. In the “hyperlink mode”, “step forward” moves the focus in a manner similar to the Tab button in Internet Explorer. “Step backward” highlights and read aloud the previous clickable hyperlink, button or area, even though not adjacent to the last read hyperlink. In the “hyperlink mode”, “step backward” moves the focus in a manner similar to the Shift+Tab combination in Internet Explorer. “Repeat current” reads aloud the currently highlighted hyperlink, button, or area—one more time. “Activate an action” triggers a hyperlink that is highlighted. (A link is read aloud using one of the first three actions.) “Change mode” switches to “navigation mode”.

“Navigation mode” does not change the display on the computer screen, but it can be visualized as a virtual list of the navigation buttons and commands at the top of the screen. These are similar to the navigation buttons and tool bars used in most Windows programs. “Step forward” highlights and reads aloud the next navigation button, menu, or menu heading on the toolbar. “Step backward” highlights and reads aloud the previous button, menu, or menu heading. “Repeat current” reads aloud the currently highlighted button or menu item (the last spoken button or menu item) one time. (If the user can remember what a button does, either because he or she remembers the icon on the button or the button's position, then reading the name of the button can be turned off. In that case, the “step forward” or “step backward” actions would just move the highlighting and the cursor.) “Activate an action” triggers the button or menu item that is highlighted. This would be like clicking on the button or menu item. “Change mode” switches back to “reading mode”.

In any of these modes, if the user comes to a link or button that activates a drop-down list, the next set of “step forward” actions will step the focus (and highlighting and reading) through the choices on the drop-down list.

In an alternate embodiment, some modes can be “turned off” (or made not accessible from the switches) while the user is learning how to use switches. This feature simplifies the use of the present invention for a user who has been using the present invention, but whose cognitive function is decreasing with time or age.

In an alternate embodiment, a “frame mode” allows the user to move the focus between frames on a web page. Otherwise, in some web pages with many sentences or objects in a particular frame, the user has to step through many sentences to get to the next frame. In an alternate embodiment, a “cell mode” allows the user to move the focus between the cells of a table on a web page. Otherwise, in some web pages with many sentences or objects in a particular cell, the user has to step through many sentences to get to the next cell.

Minor changes to the functionality of these actions and delineation of these modes, including increasing the number of modes, will not change the novel nature of the present invention or its essential workings and thus are within the scope of the present invention.

The five switches may be configured in a variety of ways, including a BAT style keyboard, with one switch beneath each finger (including the thumb) when a single hand is held over the keyboard in a natural position. Alternatively, the five switches may be five large separated physical buttons (e.g., 2.5″ or 5″ diameter switches by AbleNet, Inc., Roseville, Minn.) that the user hits with his or her hand or fist. Alternatively, the five switches are incorporated as five buttons (or areas) in an overlay on an Intellikeys® keyboard (manufactured by Intellitools, Inc., Petaluma, Calif.), where a user may use one finger to press the chosen button (or hover over the chosen area).

(By way of explanation, the Intellikeys keyboard allows different special button sets to be created and printed out on paper overlays that are placed on the keyboard. The keyboard can sense when and where a person will use his finger to push on the keyboard. The keyboard software will map the location of finger push to the button-image locations as created with the overlay creation software, and send a predefined signal to the computer to which the Intellitools keyboard is attached.)

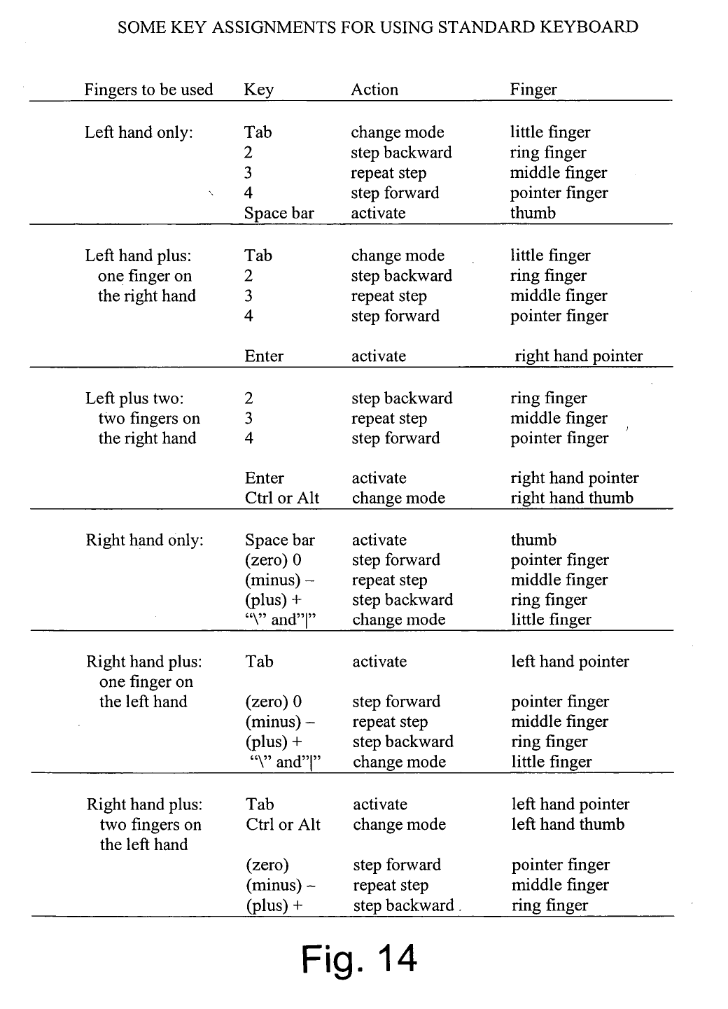

Alternately, a standard computer keyboard can be so configured in several ways. See for example FIG. 14, described below. Other configurations can be created to suit individuals who have different fingers that they can reliably control.

Point-and-Read software currently highlights regular text, hyperlinks, and navigation buttons, and highlights text and hyperlinks in different colors. The high-contrast highlighting allows many users to visually tell which mode is activated. However, the present invention has a user-selected option for speaking aloud the name of the mode which is being entered as the “Change mode” button is pressed. This option is essential for blind users.

Due to the differing colors of the Point-and-Read highlighting, many users can visually tell when the focus is on a hyperlink. The users therefore know that pressing the “activate” button will trigger a hyperlink. However, the present invention has a user-selected option for otherwise indicating that the focus is on a link. In one embodiment, the word “link” is spoken aloud before each hyperlink is read. In another embodiment, some other aural or tactile signal is given to the user. This option is essential for blind users.

For a similar reason, in an alternative embodiment, when the present invention is in reading mode, there will be aural clues that a sentence contains links. When a sentence that contains links embedded in it is about to be read aloud, the present invention will first speak the words “links in this sentence” before reading the sentence aloud from beginning to end. After reading the sentence aloud, the computer will speak the words “the links are” then read one link for each step forward action. After all the links in the sentence have been read aloud, and before the next sentence is read aloud, the computer will speak the words, “beginning next sentence”.

(Users who have opted to have the program say “link” before each link may choose to turn off the two statements “the links are” and “beginning next sentence”.)

An alternate embodiment of the present invention uses two-switch step scanning, rather than the five-switches disclosed above. The five actions detailed above (one for each of the five switches disclosed above) are instead controlled by a two-switch scanning program. The first switch physically steps through the five possible actions—one at a time. The second switch triggers the action. When reading a long text, the “step forward” action is repeated again and again. With this embodiment of the present invention, only the second switch needs to be activated to repeat the “step forward” action.

In this embodiment, the software speaks aloud the name of each action as the user uses the first switch to step through these actions.

Alternatively (or in addition), a persistent reminder is displayed of which action is ready to be triggered. In this manner, if the user turns away to look at something, when the user looks back, he or she will not forget their “place” in the program (e.g., in the flowchart). In one embodiment, there is a specific place on the computer screen (such as a place on the tool bar) which shows an icon or graphic that varies according to which action is ready to be activated. In another embodiment, a series of icons is displayed, one for each of the possible actions, and the action that is ready to be activated is highlighted or lit.

As described above, the usual action after activating a link or clickable area on an html page is for the screen-reader/browser to load a new page, but leave the program in the same mode (reading or hyperlink) and leave the cursor at the same place on the screen where the link in the previous page had been located. In an alternate embodiment, whenever the screen-reader/browser loads a new page, the mode will be set to reading mode and the cursor will be set to the beginning of the html page. Any on-screen identification of modes would reflect this (that the current mode is the reading mode). In this manner, when a link is triggered, the user can immediately continue reading by activating the step forward action.

In an alternate embodiment, when the user is in the navigation mode and activates a button that navigates to a new page (e.g., the Back button, the Forward button, or a Favorite page), the mode will be set to reading mode and the cursor will be set to the beginning of the html page.

In an alternative embodiment, the user uses the same two switches for everything, including an AAC device. (An Augmentative and Alternative Communication or AAC device is an electronic box with computer synthesized speech. It is used by people who are unable to speak. The user may type in words that the computer reads aloud using a synthesized voice. Alternatively, the user may choose pictures or icons that represent words which are then read aloud.) In this embodiment, there is a “sixth” action-choice of “Stand-by”. The “standby” action does not close the program, but returns focus of the switches to another device (or program), such as an AAC. In this manner, a user could be operating the screen-reader, but stop for a moment to use the switches to converse with someone via the AAC, and then return to the screen-reader.

In an alternate embodiment, one-switch automatic scanning is provided. The program shows icons for the different possible actions and automatically highlights them one at a time. When the desired action is highlighted, the user then triggers the switch.

### 6. Detailed Description (Part Three) of Another Preferred Embodiment of the Present Invention

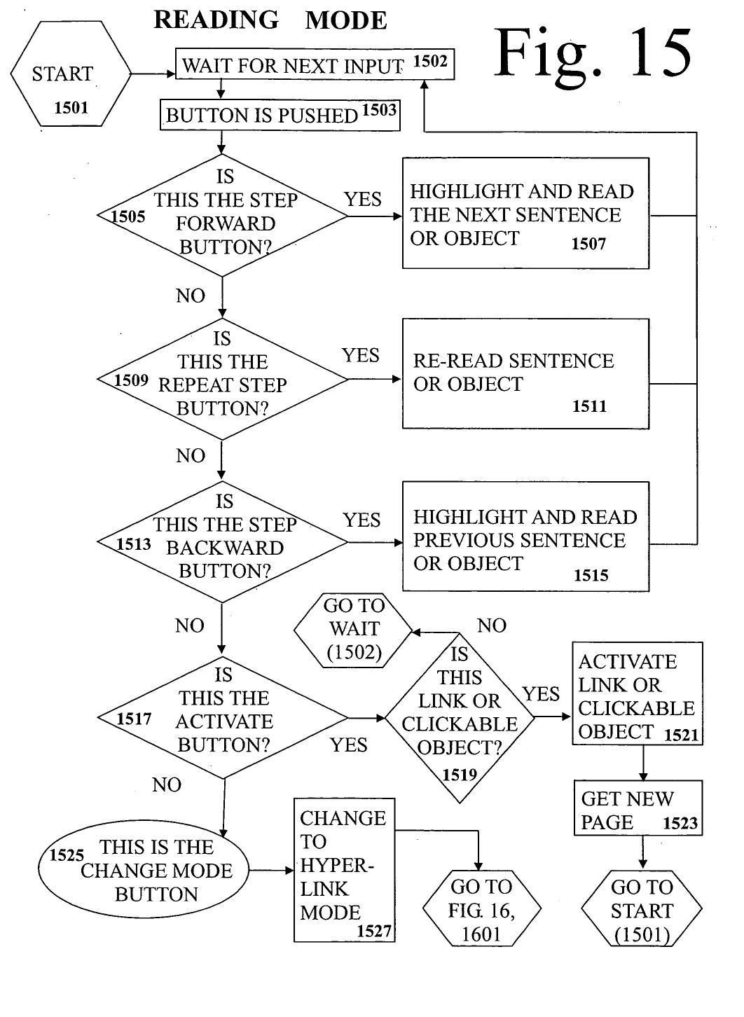

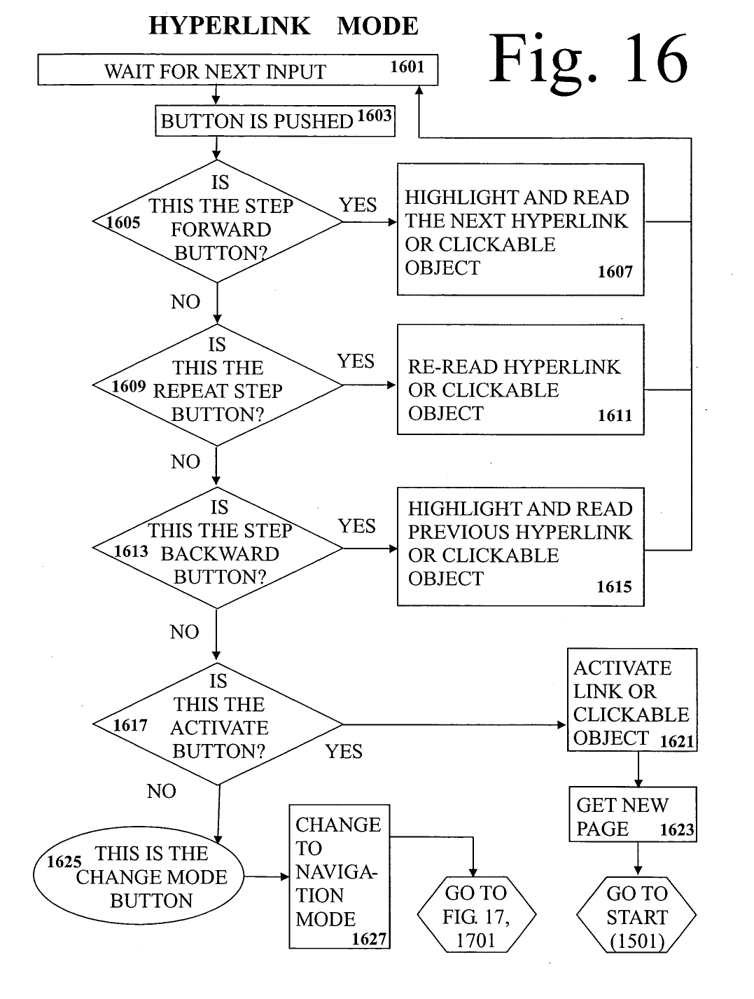

When the screen-reader shows a new page, most frequently it automatically enters the reading mode, FIG. 15, prepared to take input (start, 1501), waiting for input, 1502. When the user presses one of the input buttons, 1503, the software checks which one it is and takes appropriate action. If it is the step forward button, 1505, the screen-reader highlights and reads the next sentence or object, 1507, then waits for more input, 1502. If the button is the repeat step button, 1509, the screen-reader re-reads the current sentence or object, 1511, then waits for more input, 1502. If the button is the step backward button, 1513, the screen-reader highlights and reads the previous sentence or object, 1515, then waits for more input, 1502. (If the page has just opened, there is no previous sentence to be read, and the screen-reader does nothing—a step not shown in the flow chart—and waits for more input, 1502.) If the button is the activate button, 1517, then the screen-reader checks to see if the focus is on a clickable object, 1519. If not, there is nothing to be activated and the screen-reader waits for more input, 1502. If the focus was on a link or clickable object, 1519, then the screen-reader activates the link or clickable object, 1521, then the screen-reader gets a new page, 1523, and returns to start, 1501. (If activating the link or clickable object does not instruct the browser to get a new page, but rather run a script, play a sound, display a new image, or the like on the current page, then the screen-reader runs the script, plays the sound, displays the new image or the like and waits for more input, 1502.) If the button is none of the above, then it is the change mode button, 1525, and the screen-reader changes to hyperlink mode, 1527, placing the focus at the beginning of the page, then waits for input in the hyperlink mode, FIG. 16, 1601.

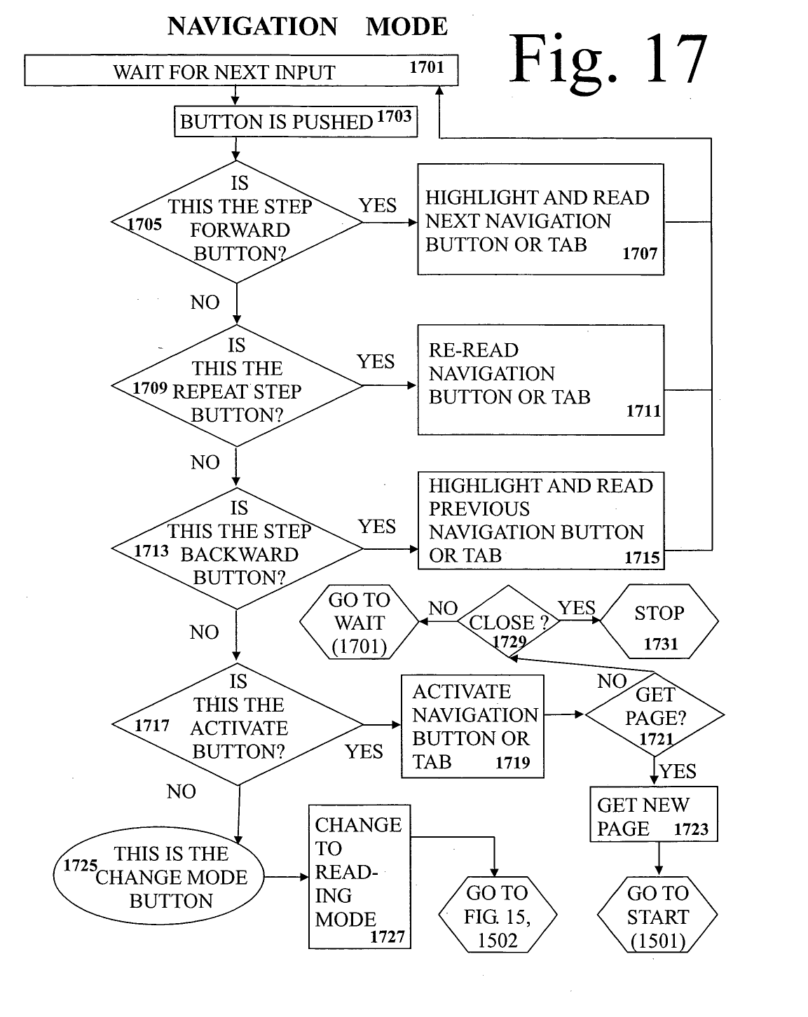

Referring now to FIG. 16, the screen-reader has entered the hyperlink mode and placed the focus at the beginning of the page, and is waiting for input, 1601. When the user presses one of the input buttons, 1603, the software checks which one it is and takes appropriate action. If it is the step forward button, 1605, the screen-reader highlights and reads aloud the next link or clickable object, 1607, then waits for more input, 1601. One link does not have to be physically adjacent to another. The screen-reader skips down the page to the next link or clickable object. If the button is the repeat step button, 1609, the screen-reader re-reads the current link or clickable object, 1611, then waits for more input, 1601. If the button is the step backward button, 1613, then the screen-reader highlights and reads the previous link or clickable object, 1615, then waits for more input, 1601. (If the focus is at the beginning of the page, before the first link, there is no previous link to be read, and the screen-reader does nothing—a step not shown in the flow chart—and waits for more input, 1602.) If the button is the activate button, 1617, then, since all objects in the hyperlink mode are clickable objects, the screen-reader activates the link or clickable object, 1621. The screen-reader then gets a new page, 1623, switches to reading mode and returns to FIG. 15, 1501, start. (If activating the link or clickable object does not instruct the browser to get a new page, but rather run a script, play a sound, display a new image, or the like on the current page, then the screen-reader runs the script, plays the sound, displays the new image or the like and waits for more input, 1601.) If the button is none of the above, then it is the change mode button, 1625, and the screen-reader changes to navigation mode, 1627, placing the focus at the beginning of the navigation tool bar, waiting for input in the navigation mode, FIG. 17, waiting for input, 1701.

Referring now to FIG. 17, when the screen-reader has entered the navigation mode and is waiting for input, 1701. When the user presses one of the input buttons, 1703, the software checks which one it is and takes appropriate action. If it is the step forward button, 1705, the screen-reader highlights and reads the next button, menu heading, or element of a drop-down menu, 1707, and then waits for more input, 1701. If the user can reliably recognize the button by the picture on its face, then the user has the option of turning off reading the button's name. In that case, the screen-reader just highlights the button. If the button is the repeat step button, 1709, the screen-reader re-reads the current button, menu heading, or element of a drop-down menu, 1711, and then waits for more input, 1701. If the user can reliably recognize the button by the picture on its face, then the user has the option of turning off reading the button's name. In that case, the screen-reader does not do anything. It merely bypasses 1711 and waits for more input, 1701. If the button is the step backward button, 1713, then the screen-reader highlights and reads the previous button, menu heading, or element of a drop-down menu, 1715, then waits for more input, 1701. If the user can reliably recognize the button by the picture on its face, then the user has the option of turning off reading the button's name. In that case, the screen-reader just highlights the button. If the button is the activate button, 1717, then, since all objects in the navigation mode are actionable objects, the screen-reader activates the button, menu heading, or element of a drop-down menu, 1719.

The navigation toolbar contains a number of clickable (or actionable) objects, including buttons, menu headings (e.g., “File”), or drop-down menus. Some drop-down menus are associated with menu headings (e.g., “File”). Other drop-down menus are associated with buttons (e.g., the favorite list associated with the “Favorite” button). In some cases, when one of these objects is activated, the browser will display a new page. One example occurs when the user activates the “Back” button. Another example occurs when the user chooses (and activates) one of the favorite web sites listed on the favorite list. Another example occurs when the “Home” button is activated and the browser retrieves the home page. Another example occurs when a “Search” button is activated and the browser displays the front page (or input page) of a search engine.

Referring back to FIG. 17, step 1719, if an object is activated, and the action associated with that object is to get a new page, 1721, then the screen-reader gets the new page, 1723, changes to reading mode, and returns to FIG. 15, 1501, start.

In some cases, the action associated with a button, tab or drop-down menu element is to close the window and quit or exit the program. If the action is to close the program, 1729, then the screen-reader quits and stops, 1731. Other buttons such as the Print button perform an action but do not get a new page. In that case, the action is performed and the focus remains on the button, and the software waits for the next input, 1701. If the button is none of the above, then it is the change mode button, 1725, and the screen-reader changes to reading mode, 1727, placing the focus at the beginning of the electronic document being displayed, and waits for input in the navigation mode, FIG. 15, 1502.

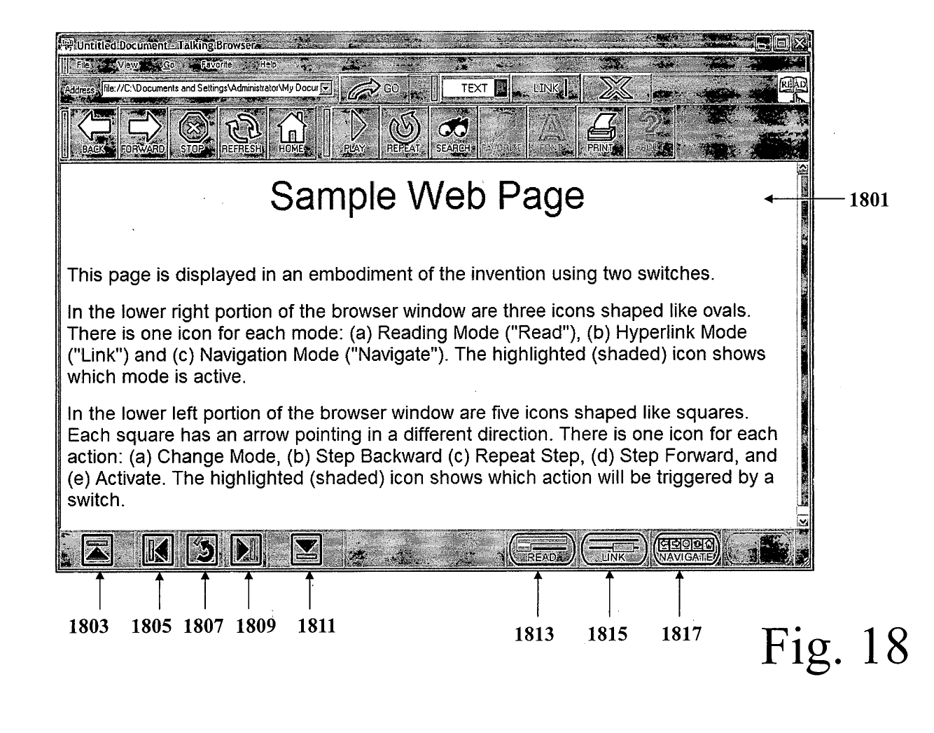

FIG. 18 shows an embodiment of the present invention for one-switch or two-switch step-scanning. FIG. 18 represents a screen shot of the present invention as it displays a sample web page. In this embodiment, the screen reader functions as an Internet browser displaying a sample web page in a window, 1801.

At the lower right portion of the browser window are three icons shaped like ovals. There is one icon for each mode: (a) Reading Mode (labeled “Read”), 1813, (b) Hyperlink Mode (labeled “Link”), 1815, and (c) Navigation Mode (labeled “Navigate”), 1817. The icon for the current mode is highlighted to act as an on-screen identification of modes and a persistent reminder to the user of just which mode is active. In FIG. 18, the active mode is Read Mode, 1813. This highlighting appears in FIG. 18 as darker shading.

At the lower left portion of the browser window are five icons shaped like squares. Each square has an arrow pointing in a different direction. There is one icon for each action: (a) Change Mode, 1803, (b) Step Backward, 1805, (c) Repeat Step, 1807, (d) Step Forward, 1809, and (e) Activate, 1811. The present invention highlights the icon for the current action as a persistent reminder to the user just which action is waiting to be triggered by a switch. In FIG. 18, this action is Step Forward, 1809. This highlighting appears in the FIG. 18 as darker shading.

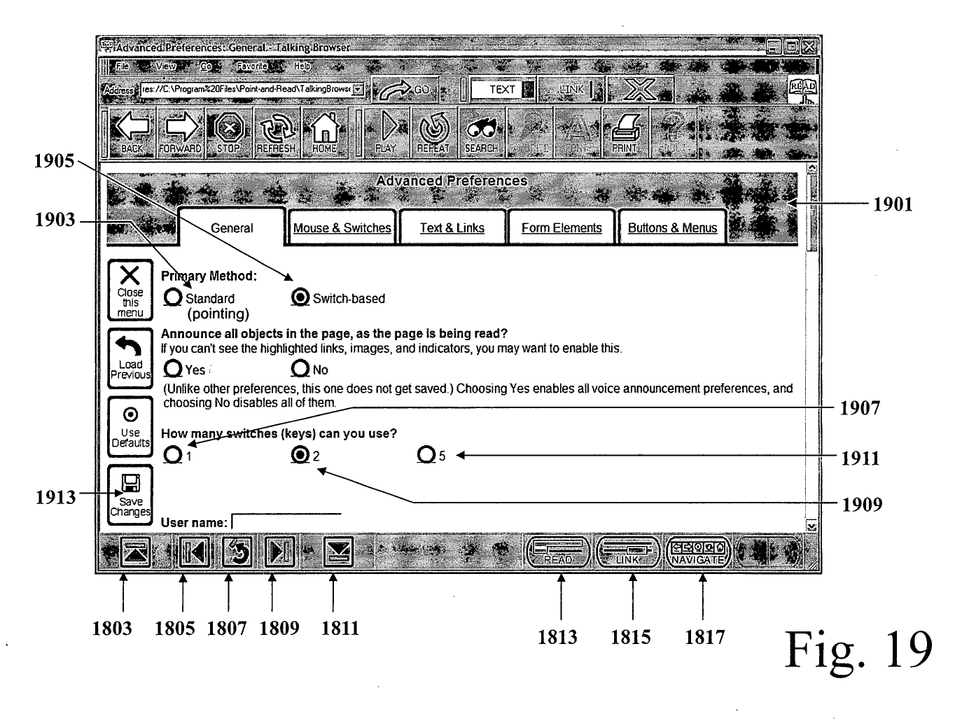

FIG. 19 shows the screen shot of an embodiment of the present invention which permits several different input device modalities and several different switching modalities. The screen shows the option page, 1901, by which the user chooses among the several input device and switching modalities. In FIG. 19, the preferences are set to a switch-based input device modality 1905 and a two-switch switching modality, 1909. This screen shot shows the possible modes (1813, 1815, 1817) along with an on-screen identification of the reading mode, 1813, as being active. Also this screen shot shows the possible actions (1803, 1805, 1807, 1809, 1811), along with a persistent reminder that step forward is the current action, 1809.

This option page allows the user to choose whether to operate in (a) the standard method (pointing device modality), 1903 which uses pointing devices for switching purposes or (b) the switch-based method (modality that uses one or more switches), 1905. The user makes this choice by activating one of the two radio buttons (1903 or 1905) and then activating the Save Changes button 1913. Once the user has chosen the switch-based method, the user chooses whether the present invention will operate with one-switch, two-switches, or five-switches (1907, 1909, 1911). The user makes this choice by activating one of the three radio buttons (1907, 1909, or 1911) and then activating the Save Changes button 1913.

Referring again to the input device modality, in one embodiment of the present invention, the input device modality operates exclusively. For example, referring to FIG. 19, if the pointing device modality is selected, only a pointing device can be used for making selections. If the switch-based modality is selected, only one or more switches can be used for making selections. Alternatively, the input device modality may operate non-exclusively.

In order to operate most computer programs, the user is required to use both a pointing device and many switches. In fact, the user is required to use a keyboard worth of switches, though frequent operations might be assigned to “hot keys”. Since mouse buttons and track-ball buttons are switches, normal use of most “pointing devices” entails both pointing and switching. In contrast, the standard method (in Point-and-Read) allows all program features to be accessed and controlled just via pointing, whereas the switch-based method (of Point-and-Read and other assistive technologies) allows all program features to be accessed and controlled via just a handful of switches. When the input device modality operates non-exclusively, pointing (or switching) accesses and controls all program features, however, switching (or pointing) provides limited auxiliary program control. For example, in the standard method, clickless pointing accesses all features but the Tab button can be used to the limited extent of advancing to the next sentence and reading it aloud (as described above). In other words, in the standard method, though a handful of actions can be taken by switches, switches cannot access every program feature that has a button on the task bar. As another example, in the standard method, a handful of switches can control all program features, but a user can still use pointing to read a sentence aloud (though not to activate a link). Though the subordinate input device cannot do anything to conflict with the primary input device, the non-exclusive feature allows one person with disabilities help or teach another person with different disabilities to use the computer.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. A method of interacting with a visually displayed document via a graphical user interface (GUI), wherein the document includes, and is parsed into, a plurality of text-based grammatical units, the method comprising:
(a) selecting a switching modality from a plurality of switching modalities, the switching modality determining the manner in which one or more switches are used to make a selection;
(b) using the selected switching modality, stepping through at least some of the grammatical units in an ordered manner by a user physically activating one or more switches associated with the GUI, each activation stepping through one grammatical unit; and
(c) reading aloud to the user each grammatical unit that is stepped through, each grammatical unit being read by loading the grammatical unit into a text-to-speech engine, the text of the grammatical unit thereby being automatically spoken.

2. The method of claim 1 wherein the document further includes one or more objects having associated text, wherein the objects have a predefined positional relationship to the grammatical units, and
step (b) further includes stepping through at least some of the grammatical units and the objects in an ordered manner by a user physically activating one or more switches associated with the GUI, each activation stepping through one grammatical unit or object; and
step (c) further includes reading each grammatical unit or object that is stepped through, each grammatical unit or object being read by loading the grammatical unit or the associated text of the object into a text-to-speech engine, the text of the grammatical unit or object thereby being automatically spoken.

3. The method of claim 2 wherein one of the switching modalities uses a plurality of switches associated with the GUI, including a switch for activating the one or more objects.

4. The method of claim 1 wherein each switching modality has a plurality of document modes.

5. The method of claim 1 wherein each switching modality has a control mode with a plurality of controls.

6. The method of claim 1 further comprising:
(d) highlighting each grammatical unit when the grammatical unit is stepped to.

7. The method of claim 1 wherein one of the switching modalities uses at least three switches associated with the GUI, including a forward step switch, a backward step switch, and a repeat step switch, and step (b) allows for stepping through the grammatical units forwards, backwards, or by repeating.

8. The method of claim 1 wherein the grammatical units are sentences.

9. The method of claim 1 wherein the switching modality defines the number of switches used.

10. The method of claim 1 wherein the document is a web page.

11. An article of manufacture for interacting with a visually displayed document via a graphical user interface (GUI), wherein the document includes, and is parsed into, a plurality of text-based grammatical units, the article of manufacture comprising a computer-readable medium holding computer-executable instructions for performing a method comprising:
(a) selecting a switching modality from a plurality of switching modalities, the switching modality determining the manner in which one or more switches are used to make a selection;
(b) using the selected switching modality, stepping through at least some of the grammatical units in an ordered manner by a user physically activating one or more switches associated with the GUI, each activation stepping through one grammatical unit; and
(c) reading aloud to the user each grammatical unit that is stepped through, each grammatical unit being read by loading the grammatical unit into a text-to-speech engine, the text of the grammatical unit thereby being automatically spoken.

12. The article of manufacture of claim 11 wherein the document further includes one or more objects having associated text, wherein the objects have a predefined positional relationship to the grammatical units, and
step (b) further includes stepping through at least some of the grammatical units and the objects in an ordered manner by a user physically activating one or more switches associated with the GUI, each activation stepping through one grammatical unit or object; and
step (c) further includes reading each grammatical unit or object that is stepped through, each grammatical unit or object being read by loading the grammatical unit or the associated text of the object into a text-to-speech engine, the text of the grammatical unit or object thereby being automatically spoken.

13. The article of manufacture of claim 12 wherein one of the switching modalities uses a plurality of switches associated with the GUI, including a switch for activating the one or more objects.

14. The article of manufacture of claim 11 wherein each switching modality has a plurality of document modes.

15. The article of manufacture of claim 11 wherein each switching modality has a control mode with a plurality of controls.

16. The article of manufacture of claim 11 wherein the computer-executable instructions perform a method further comprising:
(d) highlighting each grammatical unit when the grammatical unit is stepped to.

17. The article of manufacture of claim 11 wherein one of the switching modalities uses at least three switches associated with the GUI, including a forward step switch, a backward step switch, and a repeat step switch, and step (b) allows for stepping through the grammatical units forwards, backwards, or by repeating.

18. The article of manufacture of claim 11 wherein the grammatical units are sentences.

19. The article of manufacture of claim 11 wherein the switching modality defines the number of switches used.

20. The article of manufacture of claim 11 wherein the document is a web page.

21. An apparatus for interacting with a visually displayed document via a graphical user interface (GUI), wherein the document includes, and is parsed into, a plurality of text-based grammatical units, the apparatus comprising:
(a) means for selecting a switching modality from a plurality of switching modalities, the switching modality determining the manner in which one or more switches are used to make a selection;
(b) means for stepping through at least some of the grammatical units in an ordered manner by a user physically activating one or more switches associated with the GUI, each activation stepping through one grammatical unit, wherein the selected switching modality is used by the means for stepping; and
(c) means for reading aloud to the user each grammatical unit that is stepped through, each grammatical unit being read by loading the grammatical unit into a text-to-speech engine, the text of the grammatical unit thereby being automatically spoken.

22. The apparatus of claim 21 wherein the document further includes one or more objects having associated text, wherein the objects have a predefined positional relationship to the grammatical units, and
the means for stepping further includes means for stepping through at least some of the grammatical units and the objects in an ordered manner by a user physically activating one or more switches associated with the GUI, each activation stepping through one grammatical unit or object; and
the means for reading further includes reading each grammatical unit or object that is stepped through, each grammatical unit or object being read by loading the grammatical unit or the associated text of the object into a text-to-speech engine, the text of the grammatical unit or object thereby being automatically spoken.

23. The apparatus of claim 22 wherein one of the switching modalities uses a plurality of switches associated with the GUI, including a switch for activating the one or more objects.

24. The apparatus of claim 21 wherein each switching modality has a plurality of document modes.

25. The apparatus of claim 21 wherein each switching modality has a control mode with a plurality of controls.

26. The apparatus of claim 21 further comprising:
(d) means for highlighting each grammatical unit when the grammatical unit is stepped to.

27. The apparatus of claim 21 wherein one of the switching modalities uses at least three switches associated with the GUI, including a forward step switch, a backward step switch, and a repeat step switch, and the means for stepping allows for stepping through the grammatical units forwards, backwards, or by repeating.

28. The apparatus of claim 21 wherein the grammatical units are sentences.

29. The apparatus of claim 21 wherein the switching modality defines the number of switches used.

30. The method of claim 21 wherein the document is a web page.

31. A method of interacting with a visually displayed document via a graphical user interface (GUI), wherein the document includes, and is parsed into, a plurality of text-based grammatical units, the method comprising:
(a) selecting an input device modality from a plurality of input device modalities which determines the type of input device in which a user interacts with to make a selection;
(b) using the selected type of input device, selecting one or more grammatical units of the document; and
(c) reading aloud to the user each grammatical unit that is selected, each grammatical unit being read by loading the grammatical unit into a text-to-speech engine, the text of the grammatical unit thereby being automatically spoken.

32. The method of claim 31 wherein the input device modality includes a pointing device modality and a modality that uses one or more switches.

33. The method of claim 31 wherein the grammatical units are sentences.

34. The method of claim 31 wherein the document is a web page.

35. An article of manufacture for interacting with a visually displayed document via a graphical user interface (GUI), wherein the document includes, and is parsed into, a plurality of text-based grammatical units, the article of manufacture comprising a computer-readable medium holding computer-executable instructions for performing a method comprising:
(a) selecting an input device modality from a plurality of input device modalities which determines the type of input device in which a user interacts with to make a selection;
(b) using the selected type of input device, selecting one or more grammatical units of the document; and
(c) reading aloud to the user each grammatical unit that is selected, each grammatical unit being read by loading the grammatical unit into a text-to-speech engine, the text of the grammatical unit thereby being automatically spoken.

36. The article of manufacture of claim 35 wherein the input device modality includes a pointing device modality and a modality that uses one or more switches.

37. The article of manufacture of claim 35 wherein the grammatical units are sentences.

38. The article of manufacture of claim 35 wherein the document is a web page.

39. An apparatus for interacting with a visually displayed document via a graphical user interface (GUI), wherein the document includes, and is parsed into, a plurality of text-based grammatical units, the method comprising:
(a) means for selecting an input device modality from a plurality of input device modalities which determines the type of input device in which a user interacts with to make a selection;
(b) means for selecting one or more grammatical units of the document using the selected type of input device; and
(c) means for reading aloud to the user each grammatical unit that is selected, each grammatical unit being read by loading the grammatical unit into a text-to-speech engine, the text of the grammatical unit thereby being automatically spoken.

40. The apparatus of claim 39 wherein the input device modality includes a pointing device modality and a modality that uses one or more switches.

41. The apparatus of claim 39 wherein the grammatical units are sentences.

42. The apparatus of claim 39 wherein the document is a web page.

43. The method of claim 32 wherein the input device modality operates non-exclusively.

44. The article of manufacture of claim 36 wherein the input device modality operates non-exclusively.

45. The method of claim 40 wherein the input device modality operates non-exclusively.
